(19) United States
(12) Patent Application Publication
(10) Pub. No.: US 2024/0010035 A1
(43) Pub. Date: Jan. 11, 2024

(54) WEIGHT DISTRIBUTING HITCH SYSTEM

(71) Applicant: B & W Custom Truck Beds, Inc., Humboldt, KS (US)

(72) Inventors: Tyler Jelinek, Manhattan, KS (US); Travis M. McCall, Humboldt, KS (US); Larry Sorenson, Yates Center, KS (US); Joseph W. Works, Humboldt, KS (US); Taylor Jones, Manhattan, KS (US)

(73) Assignee: B & W Custom Truck Beds, Inc., Humboldt, KS (US)

(21) Appl. No.: 18/348,221

(22) Filed: Jul. 6, 2023

Related U.S. Application Data
(60) Provisional application No. 63/367,878, filed on Jul. 7, 2022.
(60) Provisional application No. 63/381,495, filed on Oct. 28, 2022.

(51) Int. Cl. B60D 1/24

(52) U.S. Cl. CPC B60D 1/247

(57) ABSTRACT

A weight distributing hitch system for towing a trailer behind a vehicle includes a trailer having a trailer frame and a coupler mounted on the front end of the trailer frame, a hitch ball mount, a spring arm assembly, and a linear actuator assembly. The spring arm assembly includes first and second spring arms, each having a first end connected to a first engaging structure configured to engage with the hitch ball mount, and a second end connected to a second engaging structure configured to serve as an actuator mount. The first engaging structure is configured to slidably engage with the hitch ball mount. The linear actuator assembly comprises a linear actuator having a first end connected to the actuator mount of the spring arm assembly and a second end connected to the trailer frame, wherein the linear actuator applies a load to the spring arm assembly.

### RELATED APPLICATIONS

This application claims the benefit of U.S. Provisional Patent Application Ser. No. 63/367,878, entitled Weight Distributing Hitch System, filed Jul. 7, 2022, and U.S. Provisional Patent Application Ser. No. 63/381,495, entitled Jack Mounted Support Bracket for a Weight Distributing Hitch System, filed Oct. 28, 2022, the disclosures of which are incorporated herein in their entirety by reference.

### BACKGROUND OF THE INVENTION

### Field of the Invention

The present invention relates generally to the field of vehicle trailer hitches. More specifically, the present invention relates to weight distributing and sway control trailer hitches.

### Background of the Invention

Many types of towing hitches exist and are known to those in the art, including Gooseneck, fifth wheel, and rear receiver or bumper hitches. Gooseneck or fifth wheel hitches are typically mounted near or just forward of the rear axle of the towing vehicle (commonly a pickup truck). This may help to distribute the towing load more evenly to the towing vehicle. However, they may require some additional modification to the truck bed or require after-market hitch assemblies to be installed within the bed, thereby reducing cargo space.

An alternative towing hitch such as a rear receiver or bumper hitch is mounted at the rear of the towing vehicle, thereby eliminating this potential issue. However, rear receiver or bumper hitches can cause an uneven distribution of the towing load. Typically, the load exerted on the rear receiver or bumper hitch causes the front end of the towing vehicle to be raised relative to the rear. Consequently, the steering control may be significantly reduced, and in extreme cases the front wheels may lose contact with the ground altogether. This potential loss of steering control creates a safety issue, and therefore it is desirable to distribute the towing load more evenly across the axles of the towing vehicle.

A weight distributing hitch system serves to effectively transfer the load more evenly from the rear axle of the towing vehicle to the front, thereby mitigating the problem of uneven load distribution. Weight distributing hitch systems typically incorporate spring arms or bars which may be used to take some of the weight off of the hitch ball at the rear of the vehicle. The spring arms may also be referred to as drop bars as well as deflection bars and/or deflection beams. In a typical configuration, a first end of each spring arm is connected to a ball mount and a second end of each spring arm is supported, under deflection, on a support surface of a bracket connected to a respective trailer frame. Supporting the spring arm, under deflection, on the support surface creates a moment arm which urges the first end of each spring arm and the ball mount upward to counteract any downward forces imparted on trailer tongue by the weight of the trailer and its load. As the use of rear receiver hitches and/or bumper hitches for towing trailers has become more common, consequently the demand for weight distributing hitch systems has also increased.

Typical weight distributing hitch systems require individual setup and loading of each spring arm, which may be a tedious and repetitive process. Likewise, many weight distributing hitch systems require a system of brackets and pins to adjust the load and angle of the spring arms. This approach limits the number of possible geometries and loading configurations available, as there are only a finite number of possible pin holes available on these brackets. There remains a need for a weight distributing hitch system that is relatively easy to install and operate to impart the desired load on the spring arms to counteract the downward forces acting on the towing vehicle due to the weight of the trailer and towed item acting on the trailer hitch.

### SUMMARY OF THE INVENTION

In an embodiment, a weight distributing hitch system for towing a trailer behind a vehicle includes a trailer, a hitch ball mount and a hitch ball connected to the hitch ball mount, a spring arm assembly, and a linear actuator assembly. The trailer has a trailer frame and a coupler mounted on a front end of the trailer frame. The spring arm assembly includes first and second spring arms, each arm having a first end and a second end. The spring arm assembly also includes a hitch ball mount engaging structure, which is mounted on and extends above a front bracket. The front bracket extends over the first ends of the first and second spring arms. The hitch ball mount engaging structure is configured to removably and pivotally engage with the hitch ball mount. The spring arm assembly further includes an actuator mount connected to a rear bracket, which extends below the second ends of the first and second spring arms. The actuator mount extends between and rearwardly from the second ends of the first and second spring arms. The linear actuator assembly includes an actuator mounting bracket which is securable to the trailer frame behind the trailer coupler, as well as a linear actuator. The linear actuator has a first and a second end, wherein the first end is connected to the actuator mount of the spring arm assembly, and the second end is connected to the actuator mounting bracket.

In some embodiments, the actuator mount includes a clevis having at least one pair of aligned openings in which an actuator mounting pin is received. The actuator mount may include first and second clevis plates, each plate having a slot for receiving an actuator mounting pin. The first and second clevis plates are connected to the rear bracket by means for adjusting a vertical position of the pin receiving slots of the first and second clevis plates relative to the rear bracket.

In further embodiments, the hitch ball mount engaging structure comprises a fork. The hitch ball mount includes a flange having a pin receiving hole formed in a portion of the flange extending rearward. A locking pin is mounted on the fork and biased to engage the pin receiving hole when the fork engaging engages the hitch ball mount head.

In certain embodiments, the linear actuator is a hydraulic actuator, and the weight distributing hitch system includes a hydraulic fluid reservoir, a pump for pumping the hydraulic fluid from the reservoir to the pump through a hydraulic fluid supply line. Additionally, a check valve is positioned on the supply line between the pump and the hydraulic actuator to limit the draining of hydraulic fluid from the actuator past the check valve and through the pump. The system further includes a pressure relief valve connected to the hydraulic supply line between the pump and the check valve. The system may additionally include a hydraulic fluid return line connecting the hydraulic actuator to the reservoir, a needle valve on the hydraulic fluid return line operable to control a rate of flow of hydraulic fluid from the hydraulic actuator to the reservoir, and a pressure indicator between the check valve and the hydraulic actuator.

In embodiments, a weight distributing hitch system for towing a trailer behind a vehicle with a coupler mounted on a front end of the trailer includes a bracket for supporting a spring arm assembly of said weight distributing hitch. The bracket includes a trailer jack coupled to the front end of the trailer frame and a bracket having a first offset portion secured by a U-shaped bolt to a lower portion of the trailer jack and a second offset portion supporting a hitch head engaging portion of the spring bar assembly.

In yet another embodiment of the invention, a weight distributing hitch system for towing a trailer behind a vehicle, includes a trailer, a hitch ball mount, a spring arm assembly, and a linear actuator assembly. The trailer has a trailer frame and a coupler mounted on a front end of the trailer frame. The weight distributing hitch system includes a hitch ball mount and a hitch ball connected to the hitch ball mount, and a spring arm assembly. The spring arm assembly includes first and second spring arms, each having a first end and a second end, and a hitch ball mount engaging structure mounted on and interconnecting the first ends of the first and second spring arms, the hitch ball mount engaging structure configured to removably and pivotally engage with the hitch ball mount. The spring arm assembly further includes a first actuator mount connected to and extending rearwardly from the second end of the first spring arm, the first actuator mount comprising first and second clevis plates having a plurality of holes, each hole configured to receive an actuator mounting pin at a plurality of vertical positions, and a second actuator mount connected to and extending rearwardly from the second end of the second spring arm, the second actuator mount comprising first and second clevis plates having a plurality of holes, each hole configured to receive an actuator mounting pin at a plurality of vertical positions. The linear actuator assembly includes an actuator mounting bracket securable to the trailer frame behind trailer coupler, a first linear actuator having a first end and a second end, wherein the first end connects to the first actuator mount, and the second end connects to the actuator mounting bracket. The linear actuator assembly further includes a second linear actuator having a first end and a second end, wherein the first end connects to the second actuator mount, and the second end connects to the actuator mounting bracket.

In another embodiment of the invention, a method of restoring load to a front axle of a towing vehicle having a trailer connected to the towing vehicle includes providing a user with a hitch assembly including a hitch head including a hitch ball and a hitch ball mount, a spring arm assembly connectable to the hitch ball mount, a hydraulic actuator connectable between the spring arm assembly and a trailer frame of the trailer, a pump connected between the hydraulic actuator and a hydraulic fluid reservoir by a hydraulic fluid supply line and a pressure gauge connected to the hydraulic fluid supply line between the pump and the hydraulic actuator providing pressure readings indicative of the pressure of the hydraulic fluid in the hydraulic fluid supply line. Additionally, the method includes providing the user with access to tabulated data indicating target pressures of hydraulic fluid in the hydraulic fluid supply line indicative of obtaining selected front axle load restoration percentages for selected tongue weights. This is based upon a load imparted on the spring arm assembly by retraction of the actuator in response to pressure exerted thereon by the hydraulic fluid in the hydraulic supply line. The method also includes instructing the user to connect the hitch assembly to the towing vehicle and configure the hitch assembly; such as connecting the spring arm assembly to the hitch ball mount, connecting the actuator between the spring arm assembly and the trailer frame, and connecting the hydraulic fluid supply line between the actuator and the hydraulic fluid reservoir.

Additionally, the method includes instructing the user to determine a tongue weight of the trailer connected to the towing vehicle, instructing the user to select a front axle load restoration percentage, instructing the user to access the tabulated data and determine a target pressure of the hydraulic fluid in the hydraulic fluid supply line based upon the tongue weight determined by the user and the front axle load restoration percentage selected by the user. Finally, the user is instructed to operate the pump until a pressure reading from the pressure gauge corresponds to the target pressure.

In still a further embodiment, a method of restoring load to a front axle of a towing vehicle having a trailer connected to the towing vehicle by a hitch assembly having a hitch head, a spring arm assembly connected to the hitch head, a linear actuator connected between the spring arm assembly and a trailer frame of the trailer, and a gauge providing readings of a numerical value of a parameter correlated to a force exerted by the linear actuator on the spring arm assembly includes determining a tongue weight of the trailer connected to the towing vehicle and selecting a front axle load restoration percentage. The method further includes accessing tabulated data providing target parameters indicative of obtaining selected front axle load restoration percentages for selected tongue weights based upon a load imparted on the spring arm assembly by the actuator. Then, determining the target parameter based upon the determined tongue weight and the selected front axle load restoration percentage, and operating the actuator until a numerical reading from the gauge corresponds to the target parameter.

### BRIEF DESCRIPTION OF THE DRAWINGS

Illustrative embodiments of the present disclosure are described in detail below with reference to the attached drawing figures and wherein:

FIG. 1 is a front perspective view of a weight distributing hitch system according to an embodiment of the invention.

FIG. 2 is a top view of the weight distributing hitch system of FIG. 1.

FIG. 3 is an exploded side perspective view of the weight distributing hitch system of FIG. 1.

FIG. 4 is a rear perspective view of a hitch assembly forming part of the weight distributing hitch system of FIG. 1.

FIG. 5 is a rear perspective view of a spring arm assembly forming part of the weight distributing hitch system of FIG. 1.

FIG. 6 is a front perspective view of a spring arm assembly forming part of the weight distributing hitch system of FIG. 1.

FIG. 7 is a top exploded view of the hitch assembly of FIG. 3 and the spring arm assembly of FIGS. 5 and 6.

FIG. 8 is a partial rear exploded perspective view showing the connection between the spring arm assembly of FIGS. 5 and 6 and a linear actuator assembly.

FIG. 9 is an enlarged rear perspective view showing the connection between the spring arm assembly and the linear actuator assembly.

FIG. 10 is a partial rear exploded view showing the connection between the linear actuator assembly and a trailer frame.

FIG. 11 is a partial side exploded view showing the connection between the linear actuator assembly and a trailer frame.

FIG. 12 is an enlarged and fragmentary cross-sectional view of the weight distributing hitch system taken along line 12-12 of FIG. 2.

FIG. 13 is an enlarged side perspective view of a hydraulic assembly according to an embodiment of the invention.

FIG. 14 is an enlarged and fragmentary cross-sectional view of the connection between the linear actuator and the spring arm assembly taken along line 14-14 of FIG. 2.

FIG. 15A is a schematic of the hydraulic assembly of FIG. 13.

FIG. 15B is a schematic of another embodiment of a hydraulic assembly of a weight distributing hitch system.

FIG. 15C is a schematic of yet another embodiment of a hydraulic assembly of a weight distributing hitch system.

FIG. 16 is a front perspective view of the spring arm assembly of the weight distributing hitch system of FIG. 1 connected at a rear end to the trailer frame by an actuator and disconnected at a front end from the hitch assembly with a hitch head engaging structure of the spring arm assembly supported on a spring bar assembly support bracket connected to a trailer jack of trailer 200 with the trailer jack extended to engage the ground.

FIG. 17 is a perspective view of the spring bar assembly support bracket secured to the trailer jack.

FIG. 18 is a perspective view of the spring bar assembly support bracket of FIG. 16.

FIG. 19 is a side elevational view of a hitch head engaging structure of the spring bar assembly supported on the spring bar assembly support bracket.

FIG. 20 is a cross-sectional view taken generally along line 20-20 of FIG. 19.

FIG. 21 is a side elevational view of the hitch head engaging structure of the spring bar assembly supported on the spring bar assembly support bracket as in FIG. 19 but with the trailer jack retracted to advance the hitch head engaging structure to just below the trailer frame.

FIG. 22 is a front perspective view of a weight distributing hitch system according to another embodiment of the invention.

FIG. 23 is a top view of the weight distributing hitch system of FIG. 22.

FIG. 24 is an exploded side perspective view of the weight distributing hitch system of FIG. 22.

FIG. 25 is a rear perspective view of a spring arm assembly forming part of the weight distributing hitch system of FIG. 22.

FIG. 26 is a front perspective view of a spring arm assembly forming part of the weight distributing hitch system of FIG. 22.

FIG. 27 is a top exploded view of the hitch assembly of FIG. 24 and the spring arm assembly of FIGS. 25 and 26.

FIG. 28 is an enlarged rear perspective view showing the connection between the spring arm assembly and the linear actuator assembly.

FIG. 29 is an enlarged and fragmentary cross-sectional view of the weight distributing hitch system taken along line 29-29 of FIG. 23.

FIG. 30 is a schematic of the hydraulic assembly forming part of the weight distributing hitch system shown in FIG. 22.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

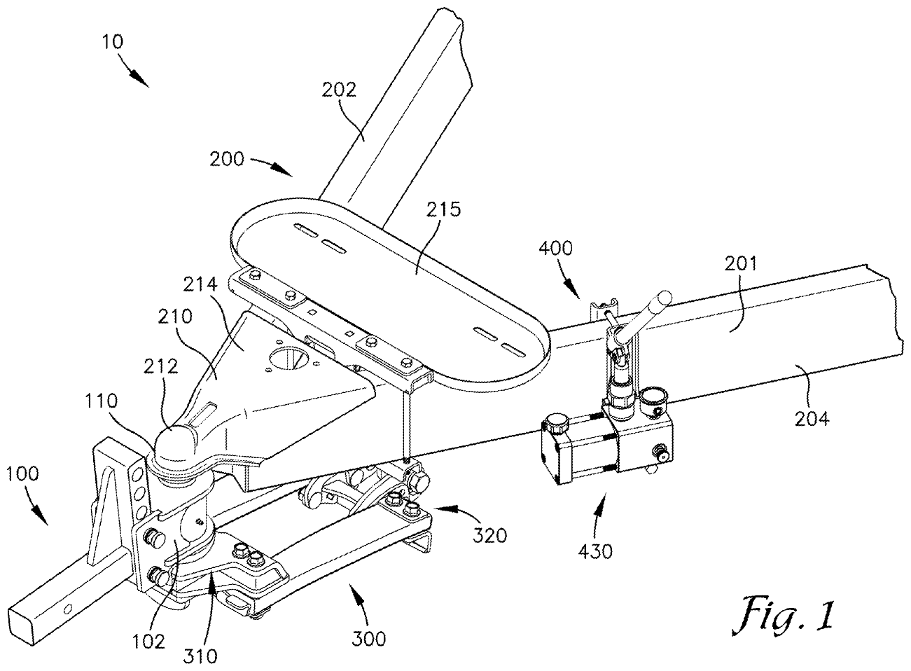

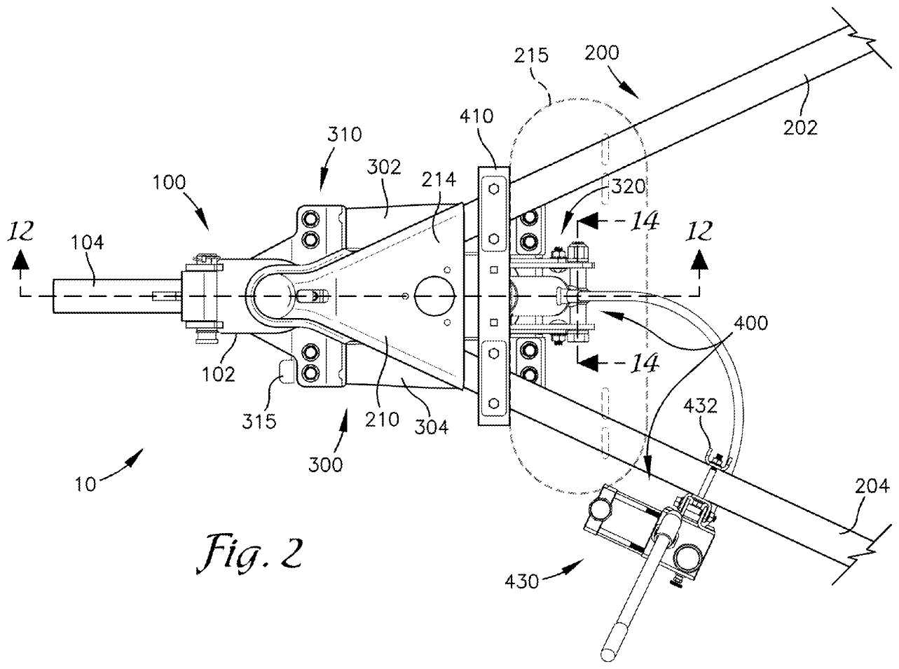

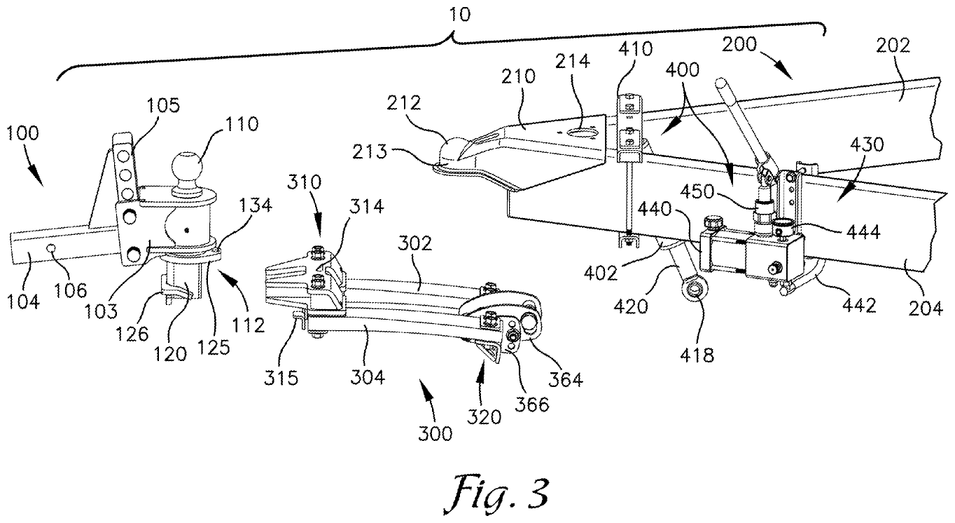

FIGS. 1-3 and 12 show a weight distributing hitch system 10, comprising a hitch assembly 100, a trailer 200, a deflection bar or spring arm assembly 300, and a linear actuator assembly 400. The weight distributing hitch system 10 is used to connect a trailer 200 to a towing vehicle. The trailer 200 may be of the type having a trailer frame 201 formed from a pair of angularly offset frame rails 202 and 204, which extend from a connecting portion 210 having a coupler 212. The trailer may include additional mounting and/or storage structures, such as propane tank tray 215. The coupler 212 is removably securable to a hitch ball 110 of a hitch assembly such as the hitch assembly 100. The hitch assembly 100 includes a hitch head 102 to which the spring arm assembly 300 is coupled. In the embodiment shown, the spring arm assembly 300 includes a hitch engaging structure 310 at a first end for removably coupling the spring arm assembly 300 to the hitch assembly 100. The spring arm assembly 300 includes an actuator engaging structure 320 at a second end thereof to which the linear actuator assembly 400 may be connected. A first end of the linear actuator assembly 400 may be coupled to the spring arm assembly 300 and a second end of the linear actuator assembly 400 may be removably coupled to the trailer frame 201.

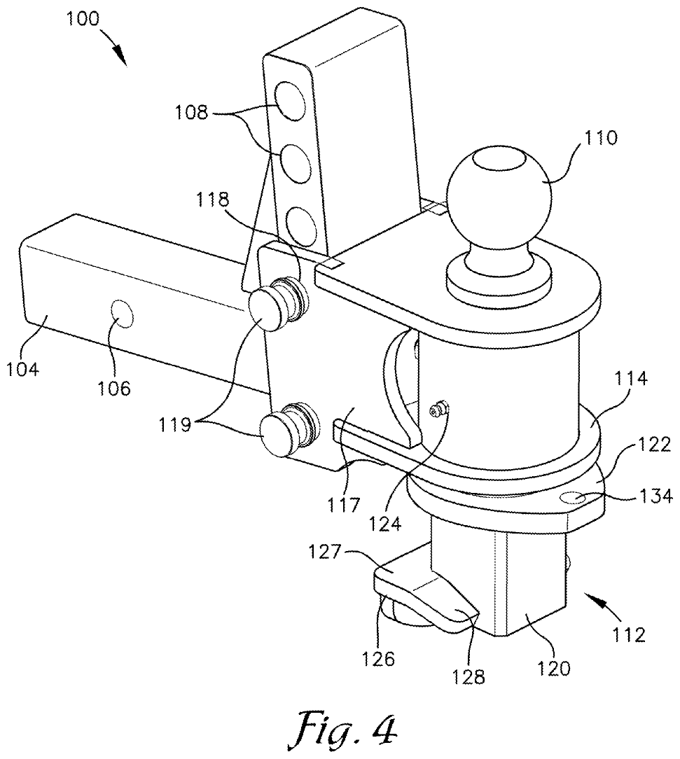

The hitch assembly 100 shown in FIG. 4 extends from and is directly connected to a towing vehicle via a hitch base or draw bar assembly 103. The draw bar assembly 103 includes a hitch shank 104 and a draw bar 105 connected to and extending perpendicular to a distal end of the hitch shank 104. A pin receiving hole 106 is formed through the shank 104 for receiving a hitch pin to secure the draw bar assembly 103 to a hitch receiver mounted on a towing vehicle. The hitch head 102 may be connected to the draw bar assembly 103 via pins 107 inserted through mount holes 108 formed in the draw bar 105 of the draw bar assembly 103. A plurality of holes 108 allows for the hitch head 102 to be attached to the draw bar 105 at a variety of heights.

The hitch head 102 includes the hitch ball 110 secured to a hitch ball mount 111 and a spring arm mount 112 rotatably connected to the hitch ball mount 111 and extending downward relative thereto. The hitch ball mount includes a bearing or cylindrical sleeve 114 connected to and supported between upper and lower support plates 115 and 116. Vertical flange plates 117 with vertically aligned sets of pin receiving holes 118 formed therein project forward from the cylindrical sleeve 114. The vertical flange plates 117 may be positioned on opposite sides of the draw bar 105 and pins 119 may then be inserted through holes 118 in the flange plates 117 and holes 106 in the draw bar 105 aligned therewith to secure the hitch head 102 to the draw bar 105 at a selected vertical position.

The spring arm mount 112 is formed as a central post or shaft 120 having an upper section 121 and a lower section 122. The upper section 121 is generally circular in cross-section and extends into cylindrical sleeve 114. The upper section 121 of the post 120 has an outer diameter which is just smaller than the inside diameter of the sleeve 114 to permit rotation of the upper section 121 of post 120 within and relative to sleeve 114. A set screw 123 extends through the cylindrical sleeve 114 and into a groove 124 formed around the circumference of the upper section 121 to retain the central post 120 within the cylindrical sleeve 114. The lower section 122 of the post 120 may be referred to as a spring arm engaging structure and is configured to interact with a complimentary or mating engaging structure 310 disposed on the spring arm assembly 300. In the illustrated embodiment, the lower section 122 of the central post 120 has a generally square cross section and the corners may be filleted or chamfered. It will be understood by those of skill in the art that the lower section 122 of the central post may have a cross section resembling any number of shapes, and that the complimentary engaging structure 310 of the spring arm assembly 300 may be a substantially similar, mating shape.

In the embodiment shown, upper and lower bearing plates 125 and 126 are secured to and project radially outward from the lower section 122 of the post 120 in vertically spaced relation and below flange plate 117. Upper bearing plate 125 may be substantially elliptical or egg-shaped, as shown in FIG. 4. Preferably, the largest diameter portion of the upper bearing plate 125 extends from the central post 120 in the direction of the spring arm assembly 300 and trailer frame 201. A through hole 134 is formed in and extends through the rearwardly projecting portion of the upper bearing plate 125. Through hole 134 is sized and configured to receive a pin 314 or similar engaging member extending from the hitch engaging structure 310 of the spring arm assembly 300.

The through hole 134 is substantially vertical in orientation, extending from a top surface to the bottom surface of the upper bearing plate 125. In the embodiment shown, the through hole 134 is substantially circular, although in other embodiments it may be desired for the through hole to be a variety of different shapes.

The lower bearing plate 126 is preferably secured to the central post 120. The lower bearing plate 126 helps support the complimentary hitch head engaging structure 310 disposed on the spring arm assembly 300 prior to and after securement of the hitch head engaging structure 310 of the spring arm assembly 300 to the spring arm mount 112 of the hitch assembly 100. The lower bearing plate 126 may be welded to the central post 120 or fastened to the post 120 such that it is formed integral with the post 120. The lower bearing plate 126 may include a substantially horizontal top face 127 extending partially around a perimeter of the central post 120. Furthermore, rearwardly extending segments of the lower bearing plate 126 may slope downward from the flat surface 127 in the direction of the spring arm assembly to form guide surfaces 128. The sloped guide surfaces 128 may help guide the hitch engaging structure 310 into place during installation. In some embodiments, it may be desirable for the complimentary spring arm engaging structure 320 to include an angled surfaces similar to that of guide surfaces 128. In this variation, the spring arm engaging structure 320 may be formed as a wedge and the combination of the lower bearing plate 126 and upper bearing plate 125 may form a wedge shaped receiver for enabling snug securement of the spring arm engaging structure 320 in the wedge shaped receiver.

In order to allow the vehicle to safely turn while towing a trailer 200, the spring arm mount 112 rotates about a vertical axis extending through the hitch ball 110. In the illustrated embodiment, the central post 120 rotates about the vertical axis. As the upper and lower bearing plates 125 and 126 are rigidly attached to the central post 120, they also are rotatable about the longitudinal axis extending through the hitch ball 110. Removably securing the hitch engaging structure 310 of the spring arm assembly 300 to the rotatable central post 120, and fixedly connecting the opposite end of the spring arm assembly 300 to the trailer frame 201, allows for appropriate rotation of the trailer 200 while turning.

The coupler 212 of the trailer 200 shown is of a type stamped from metal and having a socket 213 at a front end and connected to a jack mounting panel 214 secured over a nose of the trailer frame 201. A hole or bore 215 is formed through the jack mounting panel 214 through which a trailer or levelling jack 500 may be secured. The leveling jack is used to support the front end of the trailer 200 when the trailer 200 is not connected to a vehicle or is not in motion. The trailer frame 201 may also include a lower plate 220 disposed along a bottom surface of the trailer frame 201. The lower plate 220 may include a bore 224 that is substantially similar in size to and aligned with bore 215 through which the trailer jack 500 extends.

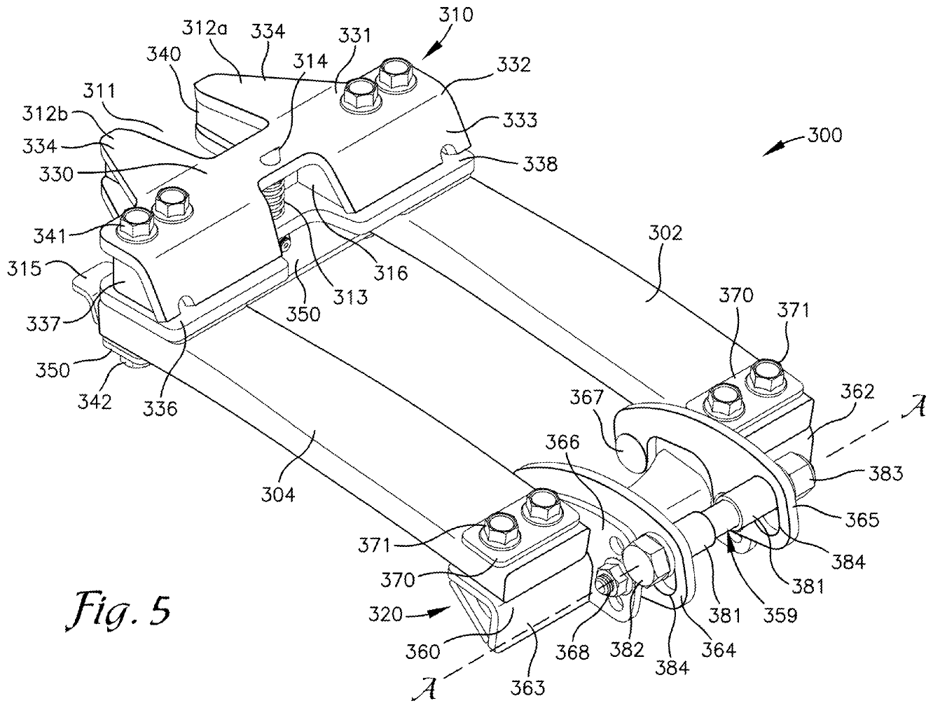

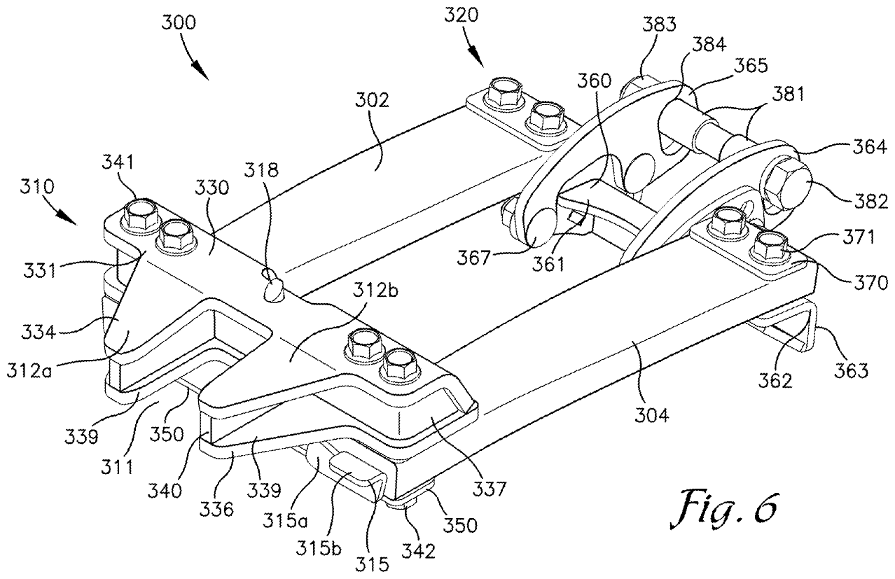

Referring now to FIGS. 5 and 6, the spring arm assembly 300 includes at least one spring arm. Preferably, the spring arm assembly comprises a pair of spring arms 302 and 304, each spring arm 302 and 304 being connected to the hitch head engaging structure 310 at a first end and connected to the actuator connecting structure 320 at a second end. As discussed previously, the hitch head engaging structure 310 is configured to be complementary to the spring arm mount 112 of the hitch assembly 100, whereby the spring arm assembly 300 and the hitch assembly 100 may be removably coupled together for use in towing a trailer 200. The actuator connecting structure 320 of spring arm assembly 300 is configured to be engaged by a first end 420 of a linear actuator 402.

Spring arms 302 and 304 may be rigidly attached to the hitch head engaging structure 310. In the illustrated embodiment, the spring arms 302 and 304 are clamped to the hitch head engaging structure 310 and secured thereof using simple mechanical fasteners such as bolts 341 and corresponding nuts 342. In other embodiments not shown, spring arms 302 and 304 may be welded to the hitch head engaging structure 310, or rigidly attached via other methods known by those skilled in the art.

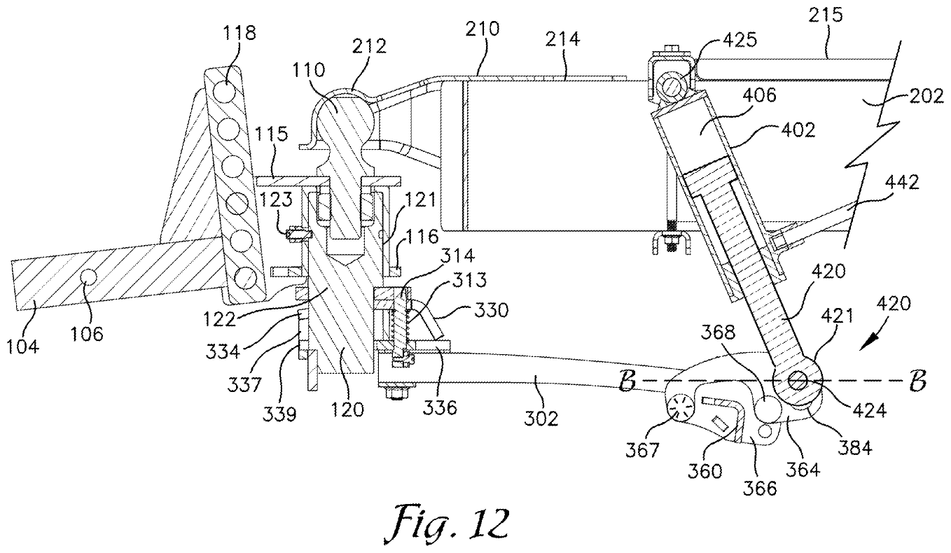

The spring arms 302 and 304 are connected together by the hitch head engaging structure 310 and the actuator connecting structure 320 to extend in substantially parallel, spaced relation as shown in FIGS. 5 and 6 or may be angularly offset from one another. The spring arms in the illustrated embodiment have a generally rectangular cross section. However, it may be desirable in other embodiments for the spring arms 302 and 304 to have a variety of cross section shapes, such as square, circular, annular, et cetera. Likewise, in the embodiment shown the spring arms 302 and 304 have a cross section which varies in size along its length, while remaining a constant shape. For ease of manufacturing or cost, it may be desirable that the spring arms 302 and 304 maintain a constant cross section shape and/or size along their complete length. In the illustrated embodiment, the spring arms 302 and 304 have a curvature along their length, as is seen in FIG. 12. In other embodiments, the spring arms may be substantially linear in shape, rather than curved as is shown.

The illustrated embodiment uses spring arms formed from a composite material such as a fiber reinforced polymeric material which could include thermoset resins. The composite material may be in the nature of fiberglass. This may allow for a more complex geometry of arm, including curvature and taper as shown. The relatively lower material stiffness and high stress limit of the glass fiber-reinforced polymer (GFRP) material allows the spring arms to be shorter than typical steel spring arms. Additionally, GFRP reduces weight of the design and may offer improved fatigue properties compared to steel. In other embodiments not seen, the spring arms 302 and 304 may be fashioned from metal, which may limit geometry but reduce the complexity of the design.

The hitch head engaging structure 310 of the spring arm assembly 300 generally comprises a fork secured to and projecting above and forward of the ends of the spring arms 302 and 304 and sized for securement around the central post 120 of the spring arm mount 112. In the embodiment shown, the hitch head engaging structure 310 is bolted onto upper surfaces of the forward ends of the spring arms 302 and 304 and extends between and interconnects the forward ends of the spring arms 302 and 304. The hitch head engaging structure 310 comprises an upper plate 330, a lower plate 336, and a spacer 337 disposed between the upper plate 330 and lower plate 336. The hitch head engaging structure 310 shown further comprises a pair of tines or prongs 312a and 312b separated by a gap 311, a locking pin 314, and a release mechanism 315.

The upper plate 330 includes a substantially planar top panel 331, a rearwardly and downwardly angled face 333, and projections 334 projecting outward or forward from the top panel 331. Projections 334 form part of prongs 312a and 312b of the engaging structure 310. The lower plate 336 is generally planar with a base panel 338 and projections 339 projecting outward or forward therefrom. Spacer 337 extends vertically between the upper and lower plates 330 and 336 to maintain an open space therebetween. Spacer 337 includes projections 340 extending between projections 334 of the upper plate 330 and projections 339 of the lower plate 336 to form the prongs 312a and 312b. Gap 311 is formed between the projections 334, 339 and 340 and is complimentary in shape to the central post 120 of the hitch assembly 100.

Mechanical fasteners or bolts 340 inserted through aligned bolt holes in the upper plate 330, lower plate 336 and spring arms 302 and 304 are used with a rectangular bracket or washer 350 and nuts 351 to rigidly connect the engaging structure 310 to the spring arms 302 and 304. The portions of the upper plate 330, lower plate 336 and spacer 337 from which the respective projections 334, 339 and 340 project and the washer 350 may be referred to as the fork base 355.

The locking pin 314 is mounted on the hitch head engaging structure 310 and is biased upward by a spring or other biasing member 313 through aligned pin receiving holes formed in the upper and lower plates 330 and 336. The spring 313 is positioned around the locking pin 314 with a lower end of the spring abutting an upper surface of the lower plate 336 and an upper end of the spring abutting against a retaining ring or the like secured in a groove formed in the locking pin 314. An upper surface 318 of the locking pin 314, extending above the upper plate 330 when the pin 314 is extended, slopes upward and rearward and generally forms a cam surface. As the prongs 312a and 312b of the hitch head engaging structure 310 are advanced around the lower section 122 of the central post 120, the upper surface 318 of the locking pin 314 engages a rear surface of the upper bearing plate 125 and further forward advancement of the hitch head engaging structure 310 forces the locking pin 314 downward against the biasing force of the spring 313. When the hitch head engaging structure 310 is advanced into engagement with the lower section 122 of the central post 120, the locking pin 314 is aligned with and is biased upward into the pin receiving hole 134 in the upper bearing plate 125 to prevent separation of the spring arm assembly 300 from the hitch head 102.

The plate 330 may also include a notch spanning a central portion of the angled face 333, such that a cavity 316 is formed. The cavity 316 is preferably adjacent to the locking pin 314, in order to allow for access to the locking pin if needed during installation.

In other embodiments, the locking pin 314 may be replaced by a small linear actuator, wherein the linear actuator may be raised or lowered in order to slidably engage with the hole 134. In these embodiments, not shown, the linear actuator may be an electric motor, a hydraulic piston, a pneumatic piston, or any other linear actuation methods now known or future-developed. The use of a linear actuator may remove the need for a biasing member completely, as the length of the pin can be controlled actively, rather than through passive means such as a mechanical spring.

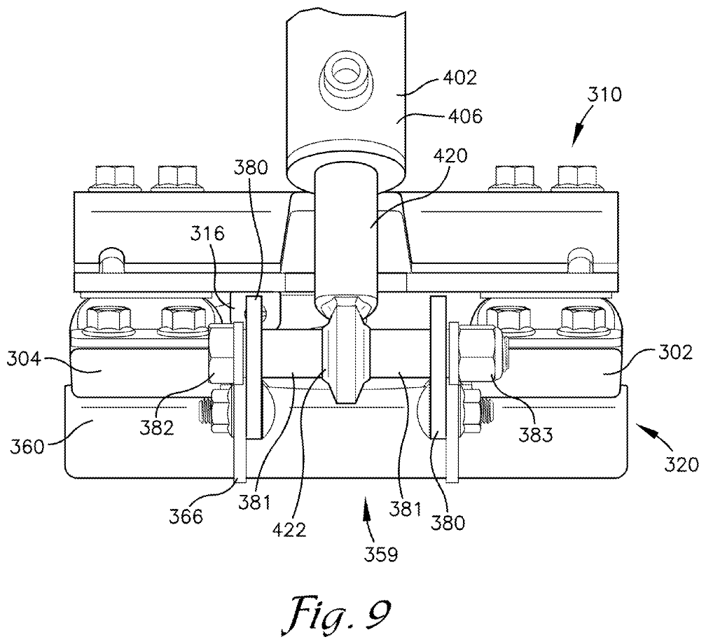

To facilitate uncoupling of the spring arm assembly 300 from the hitch assembly 100, the hitch head engaging structure 310 may further include a release mechanism 315. The release mechanism 315 may serve to lower the locking pin 314. Preferably, the locking pin 314 may be lowered below the lowermost surface of the upper bearing plate 125. In this configuration, the spring arm assembly 300 may be slidably decoupled from the hitch assembly 100. In the illustrated embodiment, the release mechanism 315 is a lever, wherein an end of the lever is connected to the bottom of the locking pin, the second end is free, and the pivot point 316 (see FIG. 9) falls in between the first and the second end. To improve ergonomics and as best seen in FIG. 6, the lever 315 may have a connecting portion 315a and a tab 315b, wherein the tab 315b is located at the free end of the lever. In the illustrated embodiment, the tab 315 extends horizontally from the lever. To lower the locking pin 314 and therefore decouple the spring arm assembly 300 from the hitch assembly 100, the user lifts or pivots the free end of the lever upwards (i.e., towards the hitch ball 110) on the tab 315 which pivots the opposite end and the locking pin 314 connected thereto downward against the biasing force of the spring 313.

Rear ends of the spring arms 302 and 304 are connected together by the actuator connecting structure 320. In the illustrated embodiment, the spring arms 302, 304 are clamped to the rear engaging structure 310 via mechanical fasteners, such as bolts 371. In some embodiments, the mechanical fasteners may clamp directly to the spring arms, while in other embodiments it may be desirable to include a mounting brackets or rectangular washers 370.

The actuator connecting structure 320 generally comprises a clevis 359 mounted on a bracket 360 extending beneath and interconnecting the second ends of the first and second spring arms 302 and 304. In the embodiment shown, bracket 360 is bolted to the second ends of the sprig arms 302 and 304 by bolts 371. The bracket comprises a substantially horizontal portion 361 and a downwardly projecting lip 363. Clevis 359 is formed from two tabs or ears 364 and 365 connected to and projecting rearward from the bracket 360 in spaced apart relation with coaxial aligned pin receiving holes 384 extending through each ear 364 about an axis A. A clevis pin or bolt 382 extending through the aligned pin receiving holes 384 is securable to the ears 364.

In some embodiments, the tabs or ears 364 and 365 may be rigidly connected to or formed integral with the bracket 360 (i.e., via welding or other methods known to those skilled in the art). In other embodiments, such as that shown, the actuator connecting structure may include a pair of extensions or plates 366 which are rigidly attached to the bracket 360 and extend generally perpendicular to the surface of the bracket 360. In this embodiment, the ears are pivotally connected to the extensions 366 at a first connection point via a mechanical fastener 367, and be removably fastened to the extensions 366 at a second connection point using a mechanical fastener 368. The extensions 366 include a plurality of holes for receiving the mechanical fastener 368 at the second connection point. A plurality of holes allows for the user to attach the linear actuator assembly 400 at various heights if necessary, depending on the specific application or towing vehicle requirements.

It is foreseen that in other embodiments, the tabs or ears 364 and 365 may include a plurality of holes for receiving the mechanical fastener 368 at the second connection point, rather than the plates 366 having the plurality of holes as in the illustrated embodiment. In these embodiments, the plates 366 may have a single hole at the second connection point, similar to the ears 364 and 365 in the illustrated embodiment.

An eyelet 418 on an end of a piston 420 of a linear actuator 400 is securable to the clevis pin 382 for connecting a lower end of the linear actuator 400 to the rear end of the spring arm assembly 300.

In the embodiment shown, the pin receiving holes 384 of the clevis 359 are elliptical and formed wider than the diameter of the clevis pin 382 with the longitudinal axis of the elliptical holes 384 extending vertically. Flanged collars or bushings 381 are positioned on the bolt 382 with one bushing 381 extending through each pin receiving hole 384 and a nut 383 is secured on a threaded end of the clevis pin 382 to secure the clevis pin 382 to the clevis 359. The bushings 381 extending between the clevis pin 382 and the ears 364, 365 facilitate vertical sliding of the clevis pin 382 within the elliptical holes 384.

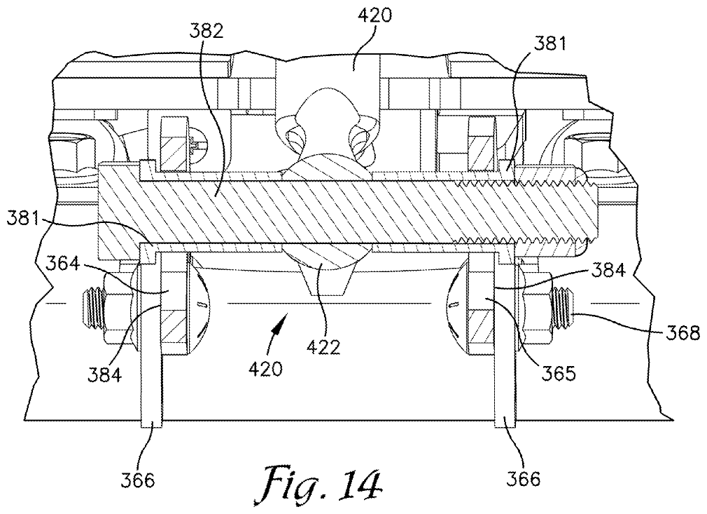

In the preferred embodiment shown in FIG. 14, the eyelet of the linear actuator 400 includes a spherical rod end bearing 422. It is foreseen that the rod end bearing 422 may also be referred to as a heim joint or rose joint, or that the rod end bearing may instead be a classical spherical joint or ball joint. As shown in FIG. 14, the rod end bearing 422 is mounted within the eyelet 418 and is formed as a truncated sphere with a bore 424 extending therethrough which is sized to receive the clevis pin 382 connects the linear actuator 400 to the spring arm assembly 300. The heim joint allows the spring arm assembly to rotate about two axes; substantially horizontal axis A, as the linear actuator applies the load to the spring arm assembly, and a longitudinal axis B, which extends generally from the draw bar assembly 103 through the center of the hitch ball 110. Longitudinal axis B, shown in FIG. 12, is perpendicular to axis A. The ability to rotate about the longitudinal axis B allows for the trailer to rotate independently from the towing vehicle, which may be beneficial when towing on uneven terrain.

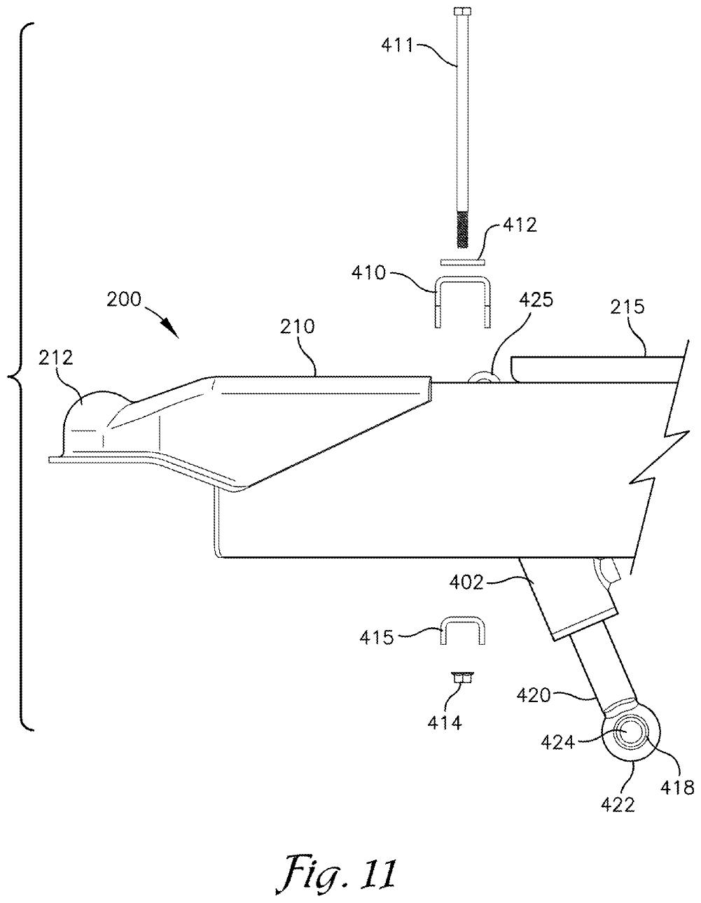

The linear actuator assembly 400 comprises a linear actuator 402 and upper and lower trailer frame mount brackets 410 and 415. A first end of the linear actuator 402 is pivotally connected to the upper trailer frame mount bracket 410. In the embodiment shown, an eyelet 425 on the base 426 of the actuator barrel 406 is pivotally connected to a pin 428 mounted on upper trailer frame mount bracket 410. As discussed previously, the eyelet 418 on the distal end of the piston 420 is pivotally connected to pin 382 on the actuator connecting structure 320. The upper trailer frame mount bracket 410 may be substantially U-shaped, as seen in FIG. 11, and may extend between the trailer arms 202 and 204. The upper bracket 410 may include a plurality of through holes, allowing for the use of mechanical fasteners such as bolts 411, washers 412, and nuts 414 to engage with the lower trailer mount bracket 415. In some embodiments, such as that shown in FIG. 11, the upper bracket 410 includes one or more slots extending longitudinally, rather than a plurality of through holes. The brackets 410 and 415 form a clamping mechanism, wherein tightening the bolts 411 and nuts 414 forms a rigid connection between the brackets 410 and 415 and the trailer frame 201.

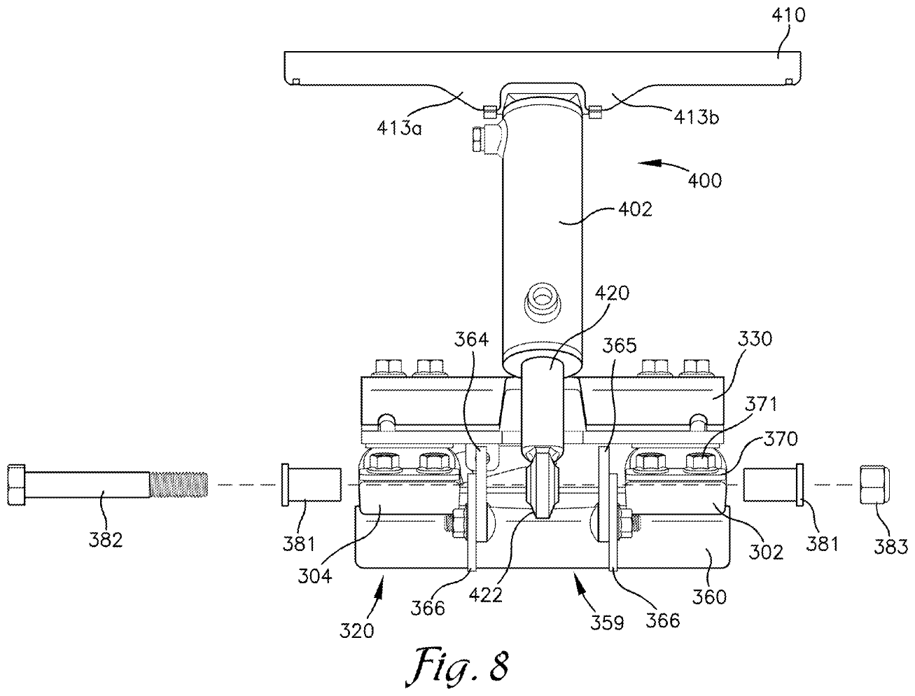

As best seen in FIG. 8, the upper trailer frame mount bracket 410 includes a pair of projections 413a and 413b extending generally downward from a lower surface of the bracket. The projections 413a and 413b each contain a through hole positioned to align coaxially with the eyelet 425 on the base 426 of the linear actuator 402, and is sized to engage with the pin 428. As seen in FIG. 12, the upper trailer frame mount bracket 410 in the illustrated embodiment is mounted between the trailer coupler 212 and the propane tank mounting structure 215, with the projections 413a and 413b extending below a top surface of the trailer frame.

The linear actuator 402 may be substantially vertical, or, as in the illustrated embodiment, angularly offset from vertical by a desired amount. With the spring arm assembly 300 connected to the hitch head 102 and the linear actuator 402, retraction of the piston 420 of linear actuator 402 applies an upwardly directed load on the rear ends of the spring arms 302 and 304 which creates a reaction moment at the opposite ends of the spring arm assembly 300. This tension and reactionary moment shift the effective towing load forwards within the towing vehicle, thereby returning the load on the front axle of the towing vehicle to its desired level, and significantly reducing the potential for reduced steering control.

By using a single linear actuator rather than a pair of linear actuators, with one actuator for each spring arm and trailer arm combination, this can significantly reduce the setup and installation time for the user. Operationally, a single actuator having a heim joint at one end results in substantially equal tension in each of the spring arms when the vehicle is turning and/or is traveling on uneven terrain. Likewise, the need for only a single actuator may reduce costs and maintenance complexity.

In the illustrated embodiment, the linear actuator 402 is hydraulically operated in extending and retracting the piston 404 within barrel 406. However, in alternative embodiments, the linear actuator may be pneumatically operated. In another embodiment, the linear actuator may be an electro-mechanical assembly, comprising an electric motor and driveshaft.

In the illustrated embodiment, the linear actuator assembly 400 further comprises a hydraulic control assembly 430. As seen in FIGS. 1-3 and 13, the hydraulic control assembly may be mounted directly to the trailer frame 201. This may be done using a clamping bracket 432 which may include a baseplate 431 on which the hydraulic control assembly 430 is mounted and connected to the trailer frame 201. The hydraulic control assembly 430 comprises a hydraulic fluid reservoir 440, a pump 450, a control valve or needle valve 460 having handle 462, and a pressure indicator 444. The hydraulic control assembly 430 is connected to the linear actuator 402 via at least one hydraulic line 442.

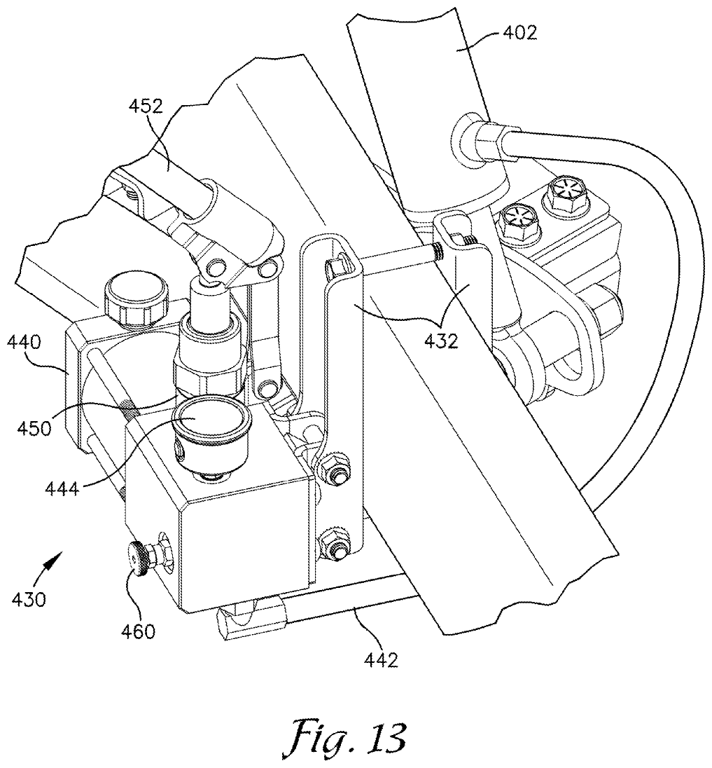

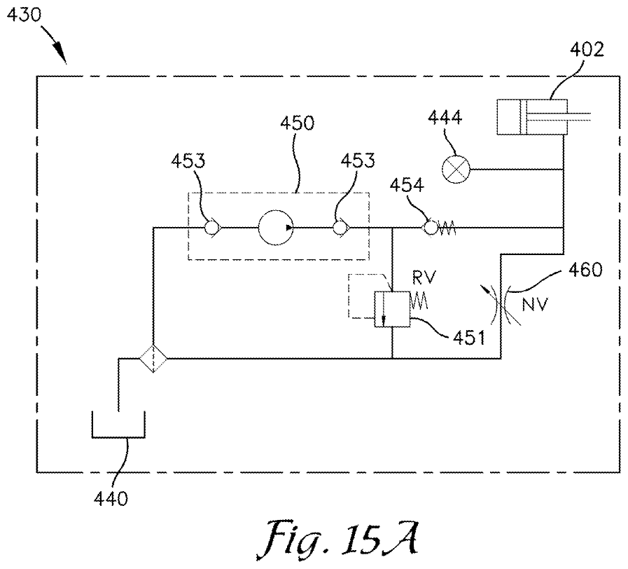

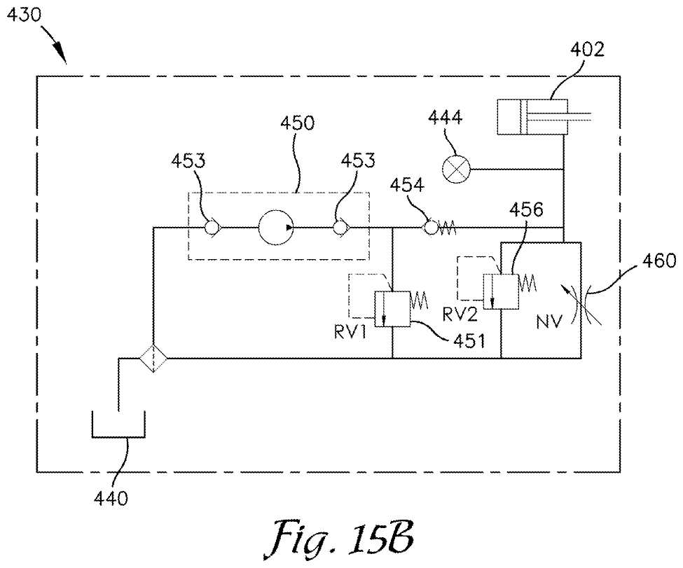

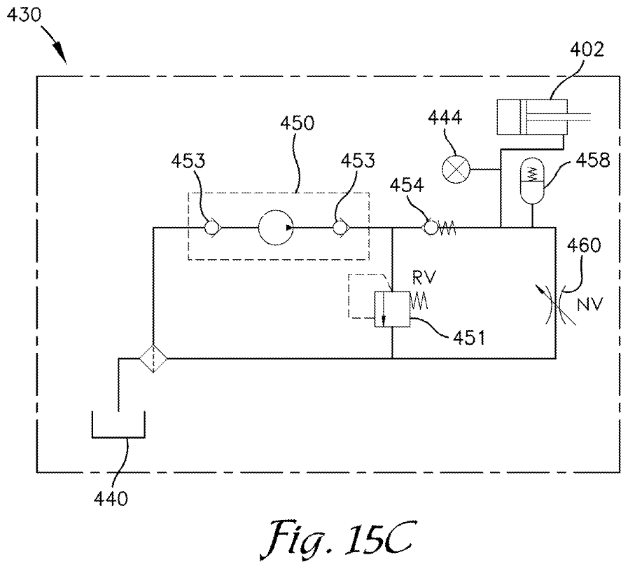

The hydraulic pump 450 may be manually operated using pump handle 452 as shown in FIG. 13 or may be electronically controlled. Pump handle 452 may be of a type adapted to receive a tire iron or an elongated bar to serve as a lever arm to facilitate operation of the pump 450. In some embodiments, the pump handle may be collapsible and/or rotatable into a storage configuration during transportation. The pump 450 may contain one or more internal check valves 453, as shown in FIGS. 15A-C. The hydraulic assembly 430 in the illustrated embodiments includes an additional check valve 454, which may help reduce leakage through the pump assembly. The pressure indicator 444 may be an analog pressure gauge as shown in the illustrated embodiment or may alternatively be a pressure sensor connected to a digital readout display.

In some embodiments, it may be desirable for the hydraulic control assembly to also include means for relieving pressure in the actuator 402 and/or other area of the hydraulic assembly 430, which may improve safety and reduce the risk of damaging the assembly during operation. For example, the hydraulic assembly shown in FIG. 15A includes a pressure relief valve 451 located generally between the pump 450 and the check valve 453 and connected to the fluid reservoir 440. The relief valve 451 may be configured to relieve pressure in the hydraulic assembly 430 by returning hydraulic fluid to the reservoir 440 when the pressure provided by the pump 450 exceeds a predetermined working pressure.

Another embodiment, shown in FIG. 15B, includes the first relief valve 451 and a second pressure relief valve 456 located generally between the check valve 454 and the linear actuator 402 and connected to the fluid reservoir 440. The second relief valve 456 may be configured to relieve pressure in the system 430 by returning hydraulic fluid to the reservoir 440 when the pressure in the actuator 402 exceeds a second predetermined threshold pressure. This second threshold pressure is preferably higher than the working pressure, (which the first relief valve 451 may be set to as described above) but lower than the pressure at which components (such as the towing vehicle, trailer, hitch assembly, etc.) may be damaged. Incorporating the second relief valve 456 which relieves pressure at a second threshold pressure effectively limits the deflection of the spring bars when the truck and trailer are at a high relative angle (e.g., when the trailer is on flat ground and truck going up or down a hill) by allowing the cylinder to extend when second threshold pressure is reached. For example, the working pressure may be approximately 2,000 psi such that the user cannot set the pressure above 2000 psi using the pump 450, while the second pressure may be approximately 3,000 psi, any pressure above which may damage the truck, trailer, and/or hitch.

In another embodiment, shown in FIG. 15C, the hydraulic assembly 430 includes relief valve 451 as well as a hydraulic accumulator 458, the accumulator 458 being located generally between the actuator 402 and the needle or control valve 460. The accumulator 458 may be a spring-loaded accumulator, like the type shown in FIG. 15C, although it is foreseen that in further embodiments the accumulator 458 may be another type known in the art. The accumulator 458 performs a function substantially similar to the second relief valve 456, wherein when the pressure in the actuator 402 exceeds a threshold value, hydraulic fluid is released from the actuator 402 into the accumulator 458 to reduce pressure. Unlike the embodiment shown in FIG. 15B, by using an accumulator 458 the hydraulic fluid is not returned directly to the reservoir 440. As a result, when the pressure in the actuator 402 drops below the pressure in the accumulator 458, hydraulic fluid is returned to the actuator 402 automatically.

The needle valve 460 is moveable using the valve dial 462 between an open position in which hydraulic fluid can flow under pressure from the barrel 406 of the linear actuator 402 to the hydraulic fluid reservoir 440 and a closed position in which hydraulic fluid is held in the barrel 406 of the actuator to maintain the piston 420 at a selected extension relative to the barrel 406 and maintain the spring arm assembly 300 under a desired load or in which additional fluid may be added to the barrel 406 through the pump 450 in order to move the piston 420 towards the desired extension relative to the barrel.

A quantitative indicator of proper weight distribution for the towing vehicle is the front axle load restoration percentage (FALR), and is known to those of skill in the art. Front axle load restoration percentages of between 50% and 100% are recommended. As an example, if the normal weight or load on the front axle of a towing vehicle is 2,000 pounds and if the front axle load is reduced by 500 pounds to 1,500 pounds, upon connection of a trailer thereto, a FALR of 100% would restore 500 pounds of load to the front axle and a FALR of 50% would restore 250 pounds of load to the front axle of the towing vehicle. For a known tongue weight (the weight exerted by the trailer on the hitch ball), the spring bar moment, which is directly related to the force exerted on the distal ends of the spring arms by the actuator and therefore the hydraulic pressure shown by the pressure indicator 444, is linearly related to the FALR. Consequently, it has been determined that there is a predictable relationship between the pressure shown by the pressure indicator 444 and the FALR for a user's known tongue weight.

In some embodiments, the weight distributing hitch system may include a complimentary mobile phone application (or other electronically accessible database), whereby the user inputs a known tongue weight and desired FALR, and the output is a target hydraulic pressure. In other embodiments, the weight distributing hitch may include tabulated hydraulic pressures and a corresponding FALR for various ranges of tongue weight. Using the electronically accessible database or tabulated data, the steps of loading the spring arms to obtain a desired weight distribution or FALR is greatly simplified. Prior to installing the spring arm assembly 300, the user will determine or measure the tongue weight of the trailer to be towed which may also include an item to be towed such as a boat. Alternatively, the user may estimate the tongue weight. The tongue weight is typically 10% to 15% of the gross weight of the trailer and any items supported on the trailer. Using the tabulated data, the user identifies a target pressure or target pressure reading corresponding to a selected FALR for the measured or estimated tongue weight. Using the mobile phone application or electronically accessible database, the user inputs the measured or estimated tongue weight and a selected FALR and the application will display a target pressure or target pressure reading to obtain the selected FALR for the measured or estimated tongue weight. After the spring arm assembly 300 is connected to the hitch ball mount 111 and the actuator assembly 400 is connected between the spring arm assembly 300 and the trailer frame 201 using the upper trailer frame mount bracket 410, the pump 450 is operated to retract the piston 404 relative to the barrel 406 of the linear actuator 402 while monitoring the displayed pressure or pressure reading on the pressure indicator 444. The pump is operated until a displayed pressure on the pressure indicator 444 corresponds to the target pressure indicative of the selected FALR for the measured or estimated tongue weight as determined using the tabulated data or mobile phone application. In an example, for a trailer having a gross weight of 10,000 pounds, an estimated tongue weight of 10% is 1,000 pounds. If the selected FALR is 75%, the tabulated data or the mobile phone application may indicate a target pressure of 1500 psi.

In other embodiments, the actuator may be actuated by means other than hydraulically, such as for example, electronically for which a different parameter associated with actuation of the actuator is indicative of the force applied by the actuator on the spring arms. For an electronic actuator, the current draw on a motor used to retract the actuator to load the spring arms to the degree or amount required to obtain the desired FALR is also linearly correlated to the desired FALR. The weight distributing hitch system may include a complimentary mobile phone application (or other electronically accessible database), whereby the user inputs a known tongue weight and desired FALR, and the output is a target current draw. In other embodiments, the weight distributing hitch may include tabulated current draws and a corresponding FALR for various ranges of tongue weight.

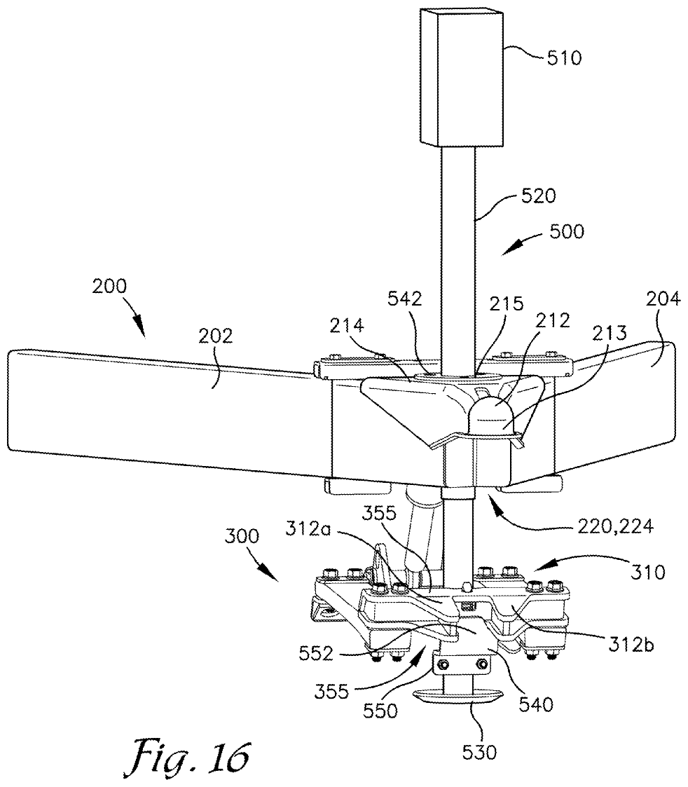

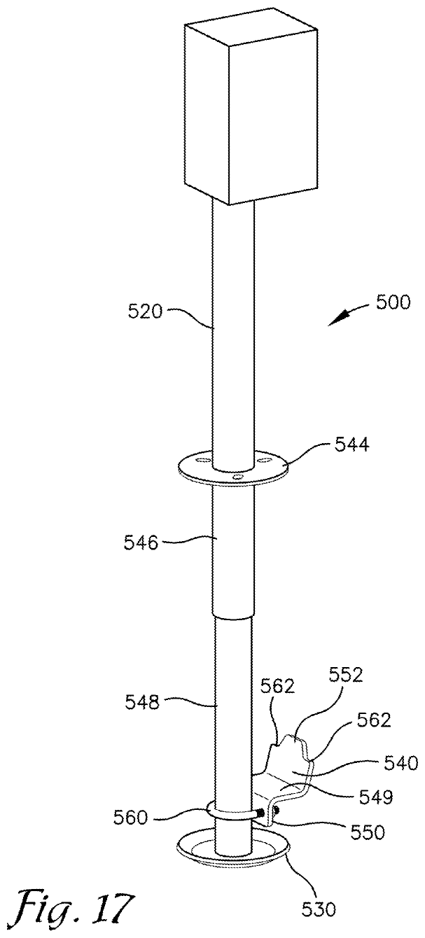

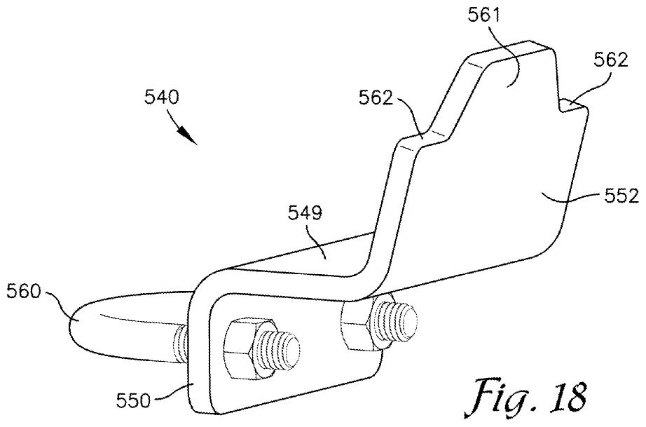

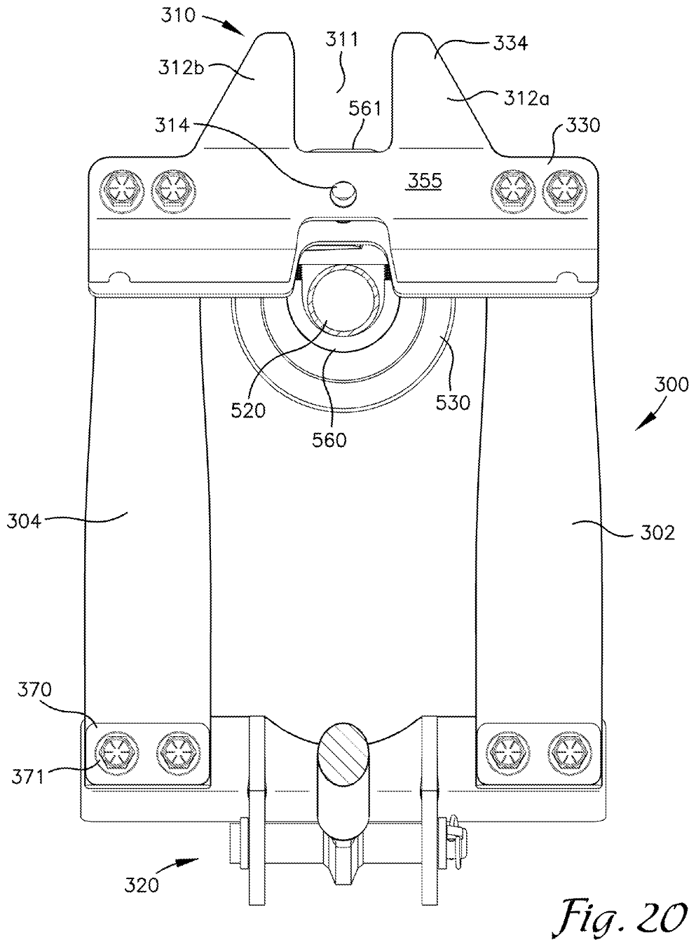

As shown in FIGS. 16-21, the leveling jack 500 is used to raise or lower the front end of the trailer 200, such as to engage or disengage the trailer 200 from a vehicle or to support the front end of the trailer 200 when the trailer 200 is not connected to a vehicle or is not in motion. The trailer jack 500 raises and lowers the front end of the trailer 200 utilizing a crank mechanism 510 which in some embodiments may be an electrically or hydraulically powered and/or a manually operated mechanism.

The trailer jack 500, also known as a hitch jack, a tongue jack or a leveling jack, includes the crank mechanism 510 to raise or lower the front end of the trailer 200, an elongated shaft 520 that extends vertically upward from a base plate 530, and the base or support plate 530 that is joined to a lower or distal end of the shaft 520. The base plate 530 extends between the distal end of the shaft and the ground or a support structure and supports the shaft 520 as it bears the weight of the front end of the trailer 200.

A spring bar assembly support bracket or cradle 540 may be bolted to the trailer jack 500 to support the hitch head engaging structure 310 of the spring bar assembly 300 off the ground when the hitch head engaging structure 310 is uncoupled from the hitch assembly 100 with the actuator 402 still connected between the upper trailer frame mount bracket 410 and the actuator connecting structure 320 on the rear end of the spring bar assembly 300, or if the trailer 200 is moved by connecting the hitch assembly 100 without connecting the hitch head engaging structure 310 of the spring bar assembly 300 to the hitch assembly 100.

In the embodiment shown, the trailer jack 500 is secured to the front end of the trailer 200 and extends through the bores 215 and 224 of the jack mounting panel 214 and the lower plate 220, respectively. The jack mounting panel 214 includes mounting holes 542 adjacent the bore 215 for securing a jack support flange 544 of the trailer jack 500 to the jack mounting panel 214 using mechanical fasteners, such as nuts and bolts. An upper portion 546 of the shaft 520 of the trailer jack 500 extends through the bore 215 in the jack mounting panel 214 and the bore 224 in the lower plate 220. A lower portion 548 of the shaft 520 is telescopically mounted within the upper portion 546 of the shaft 520 and extends or retracts to adjust the height of the attached front end of the trailer 200 from the ground. The base plate 530 is joined to the distal end of the shaft 520 and supports the shaft 520 which extends upward therefrom when the trailer jack 500 is supporting the front end of the trailer 200.

The hitch head engaging structure 310 of the spring bar assembly 300 may be positioned and supported on the spring bar assembly cradle 540 when the hitch head engaging structure 310 is not connected to the hitch assembly 100. In a preferred embodiment, the spring bar assembly cradle 540 is formed as an S-shaped, upwardly extending hook or cradle sized and configured to engage and support the hitch head engaging structure 310 of the spring bar assembly 300. The embodiment of the jack foot bracket 540 shown includes a central web 549 with a downwardly projecting mounting flange 550 formed on one side and an upwardly projecting support arm or fork engaging member 552 that engages the prongs 312a and 312b on the hitch head engaging structure 310. In the embodiment shown, the mounting flange 550 is secured to the shaft with a U-bolt 560 extending around the shaft 520 and through openings in the mounting flange 550 of the cradle 540. The cradle 540 is secured to the shaft 520 by tightening fasteners, such as nuts, to the threaded ends of the U-bolt 560 extending through openings in the mounting flange 550.

The support arm 552 extends upward from the central web 549 in spaced relation from the mounting flange 550 at a spacing greater than the width of the fork base 355. A locating finger or tab 561 of reduced width is formed on an upper end of the support arm 552 between support shoulders 562. The support arm 552 is sized wider than the gap 311 between the prongs 312a and 312b of the hitch head engaging structure 310 and the locating tab 561 is sized narrower than the gap 311 such that the prongs 312a and 312b may be supported on the support shoulders 562 of the support arm 552 with the locating tab 561 extending between the prongs 312a and 312b. Extension of the locating tab 561 between the prongs 312a and 312b limits lateral shifting of the hitch head engaging structure 310 relative to the support arm 552 to prevent the hitch head engaging structure 310 from sliding off the support arm 552 laterally.

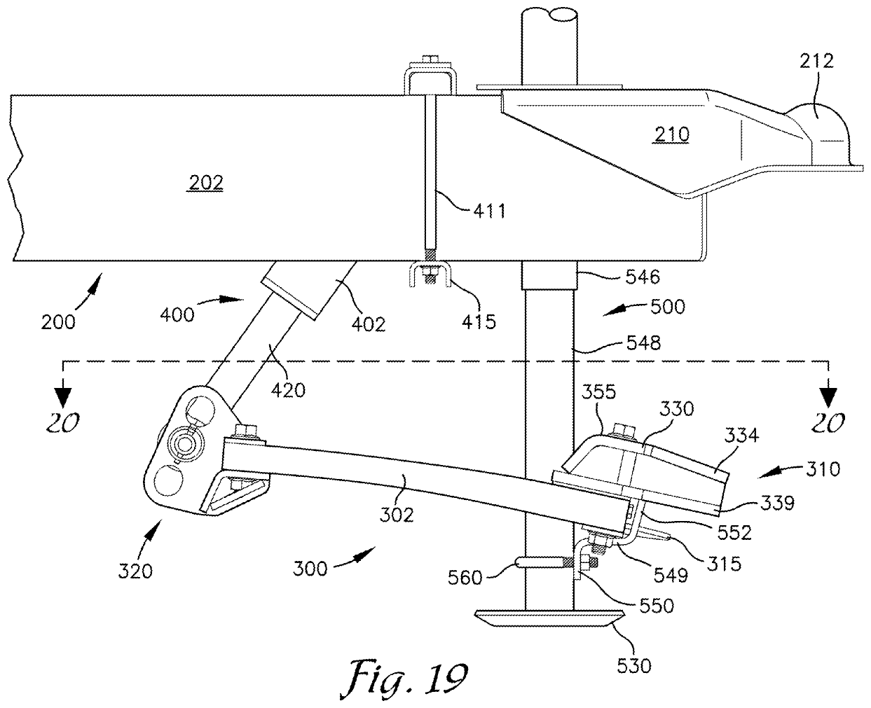

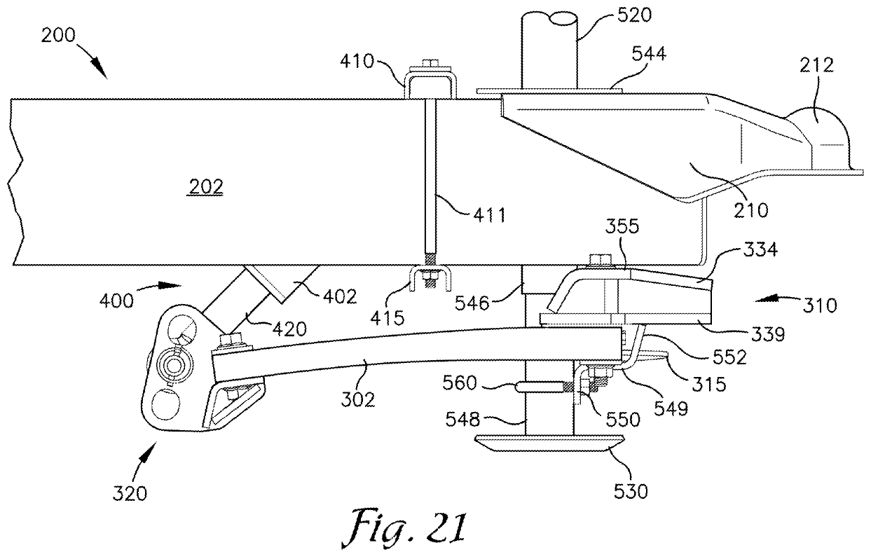

The support shoulders 562 are spaced outward from the trailer jack shaft 520 to which the cradle 540 is mounted by a spacing at least slightly greater than the width of the fork base 355 along a longitudinal axis through the spring arm assembly 300 such that when the prongs 312a and 312b are supported on shoulders 562, the fork base 355 generally fits between the locating tab 561 on support arm 552 and the jack shaft 520 of trailer jack 500. The trailer jack 500 may be vertically adjusted to adjust the front end of the trailer 200 relative to the ground with the hitch head engaging structure 310 of the spring bar assembly 300 supported on the cradle 544 above the base plate 530 and above the ground as shown in FIGS. 16 and 19. With the hitch head engaging structure 310 of the spring bar assembly 300 supported on the cradle 544 and the actuator 402 connected between the upper, trailer frame mount bracket 410 and the actuator connecting structure 320 on the rear end of the spring bar assembly 300, as the jack shaft 520 is retracted to raise the base plate 530 off of the ground, the hitch head engaging structure 310 is also lifted upward. If the jack shaft 520 is then retracted until the hitch head engaging structure 310 supported on cradle 544 is advanced upward just below the trailer frame 201, as shown in FIG. 21 and which may be referred to as a stowed position, abutment of the hitch head engaging structure 310 against the underside of the trailer frame 201, will prevent the hitch head engaging structure 310 from being lifted or moving upward off of the support shoulders 562 high enough to clear the locating tab 561 so that the hitch head engaging structure 310 cannot inadvertently fall off the cradle 544.

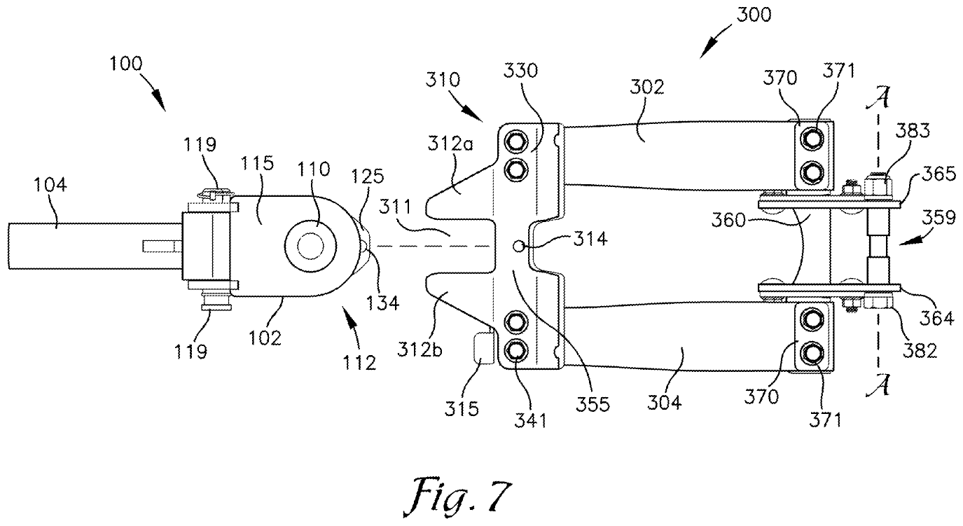

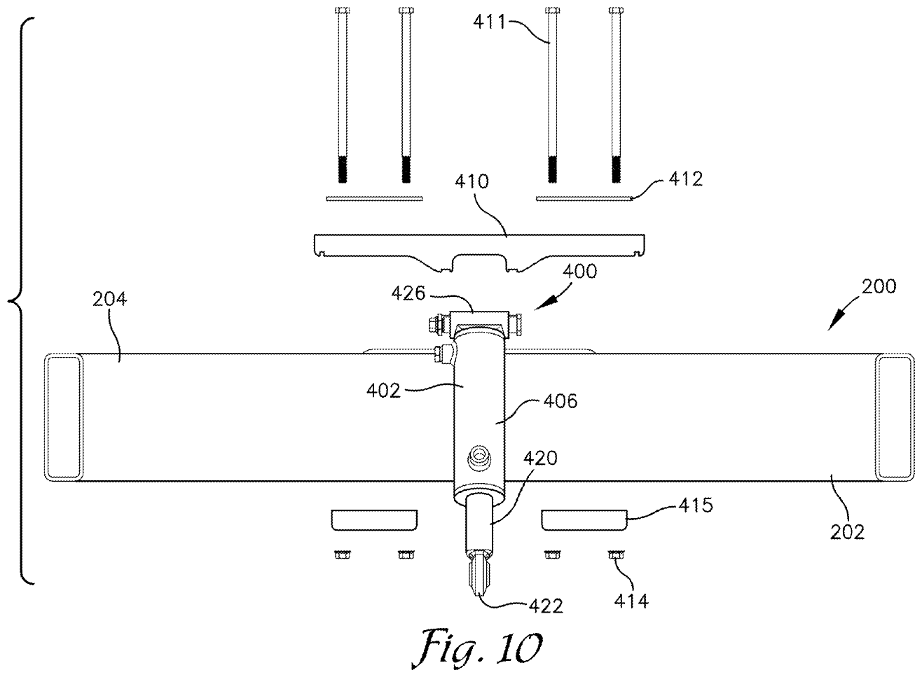

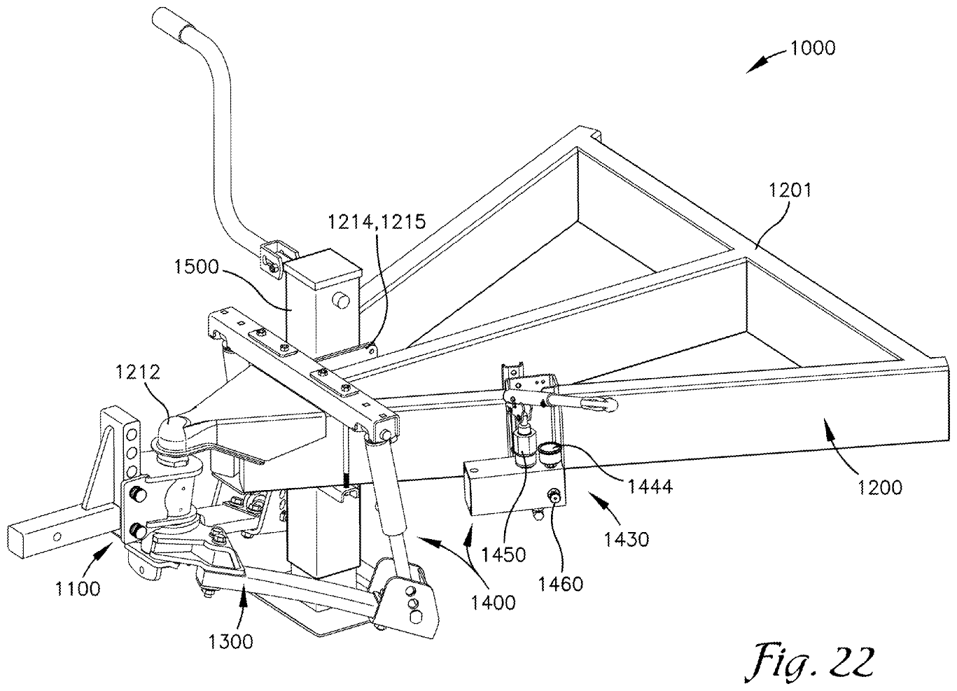

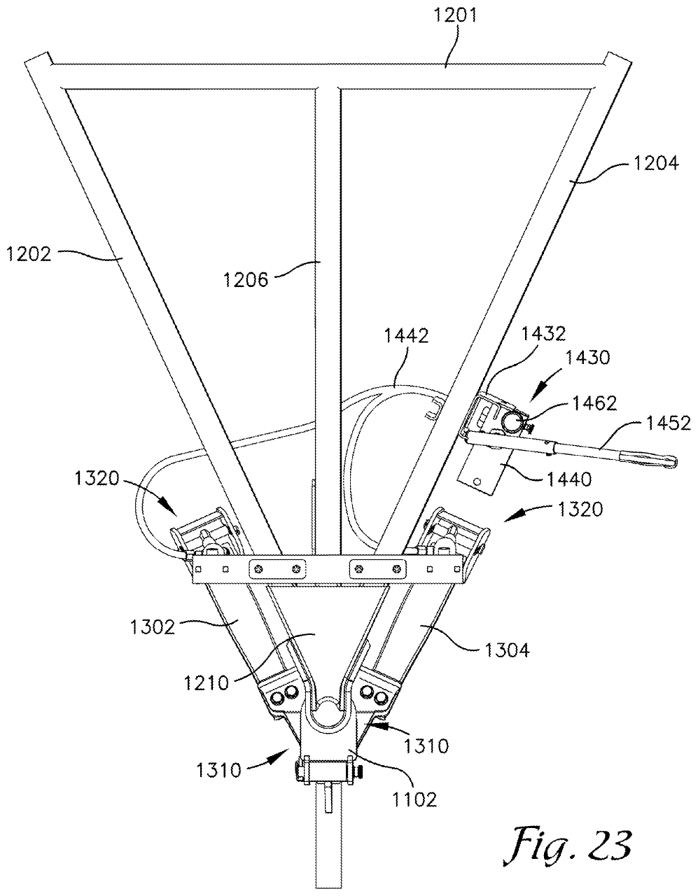

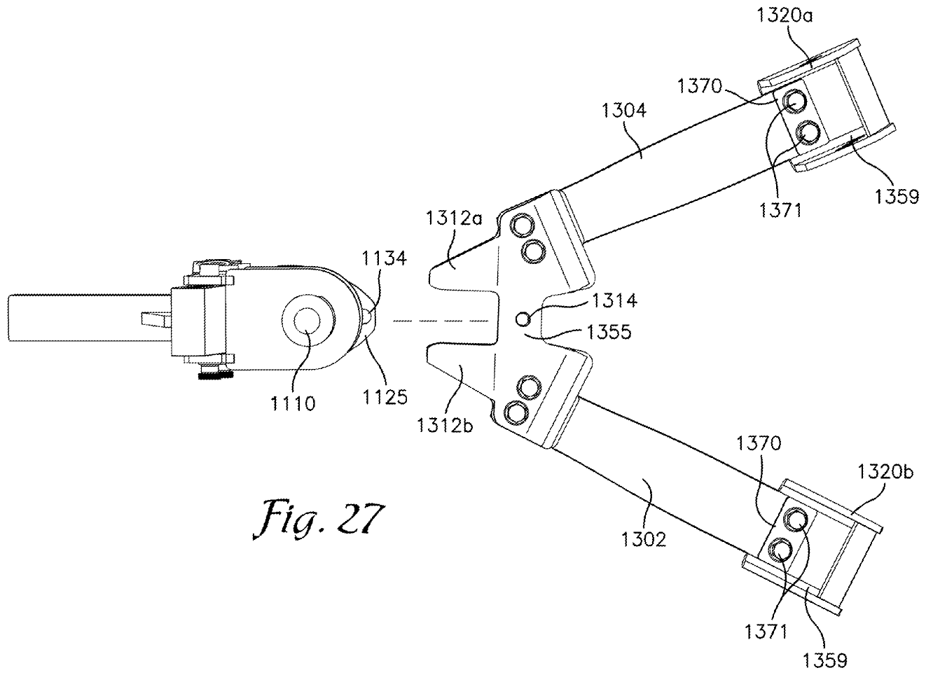

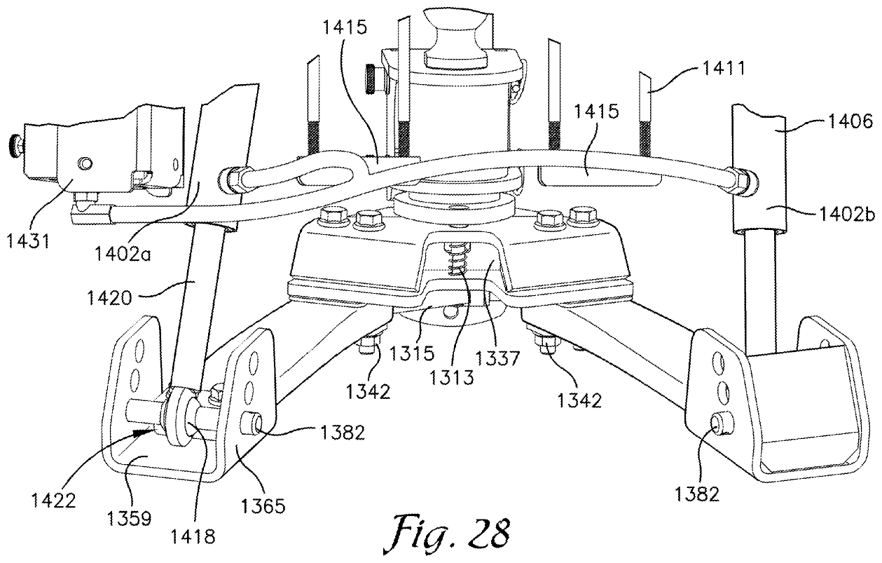

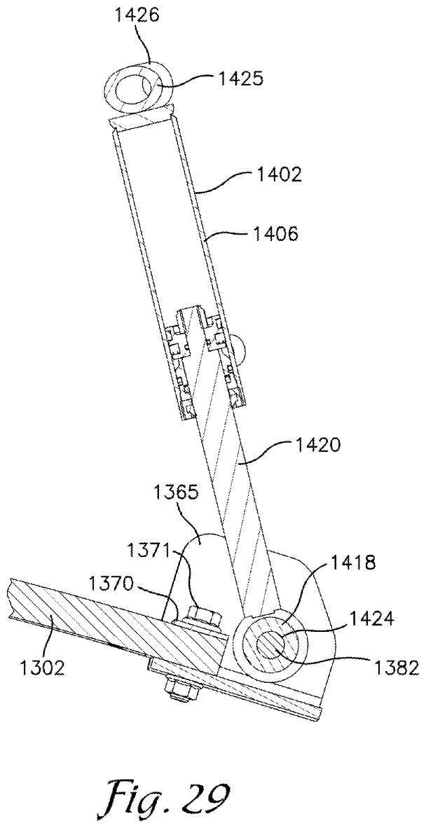

Referring now to FIGS. 22-30, a second embodiment of a weight distributing hitch system 1000 is shown. The weight distributing hitch system 1000 is similar in function to weight distributing hitch system 10 shown in FIGS. 1-14, and includes a hitch assembly 1100, a trailer 1200, a spring arm assembly 1300, and a linear actuator assembly 1400. The hitch assembly 1100 is substantially identical to the hitch assembly 100 shown in FIG. 4, and for brevity and convenience, reference numerals 1100-1199 correspond generally to reference numerals 100-199 (for example, hitch head 1102 corresponds to hitch head 102, guide surfaces 1128 correspond to guide surfaces 128, etc.), except where shown, described, or otherwise inherent.

The trailer 1200 may be of the type having a trailer frame 1201 formed from a pair of angularly offset frame rails 1202 and 1204 and a central support 1206 in a tongue section, all of which extend rearward from a connecting portion 1210 having a coupler 1212 at a front end of the trailer. Because trailer 1200 includes the central support 1206, unlike trailer 200, it is not practical and/or possible for the linear actuator assembly 1400 to include a single, central actuator, and instead the actuator assembly 1400 may utilize two parallel linear actuators 1402a and 1402b. The trailer may include additional mounting and/or storage structures, such as propane tank tray. The coupler 1212 is removably securable to a hitch ball 1110 of a hitch assembly such as the hitch assembly 1100. The hitch assembly 1100 includes a hitch head 1102 to which the spring arm assembly 1300 is coupled. In the embodiment shown, the spring arm assembly 1300 includes a hitch engaging structure 1310 at a first end for removably coupling the spring arm assembly 1300 to the hitch assembly 1100. The spring arm assembly 1300 includes a pair of actuator engaging structures 1320a and 1320b at a second end thereof to which the linear actuator assembly 1400 may be connected. A first end of each of the linear actuators 1402a and 1402b of the linear actuator assembly 1400 may be coupled to the spring arm assembly 300 and a second end of the linear actuators 1402a and 1402b of the linear actuator assembly 1400 may be removably coupled to the trailer frame 1201.

As with trailer 200, the coupler 1212 of the trailer 1200 shown is of a type stamped from metal and having a socket 1213 at a front end and connected to a jack mounting panel 1214 secured over a nose of the trailer frame 1201. A trailer jack or levelling jack 1500 may be secured to the trailer frame 1201 by mechanical fasteners via a jack mounting plate 1215. The leveling jack 1500 is used to support the front end of the trailer 1200 when the trailer 1200 is not connected to a vehicle or is not in motion. The trailer frame 1201 may also include a lower plate 1220 disposed along a bottom surface of the trailer frame 1201.

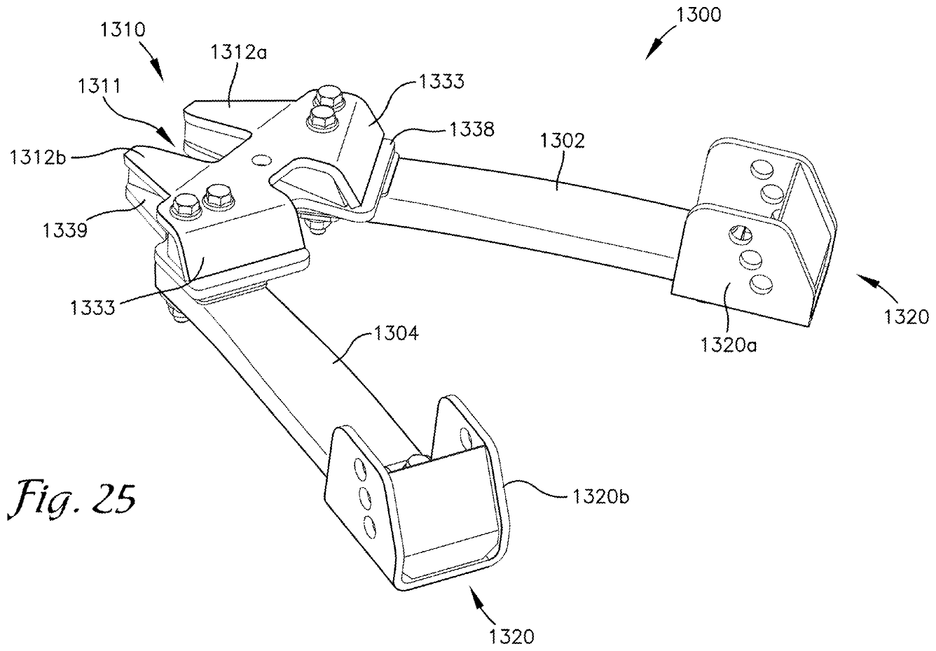

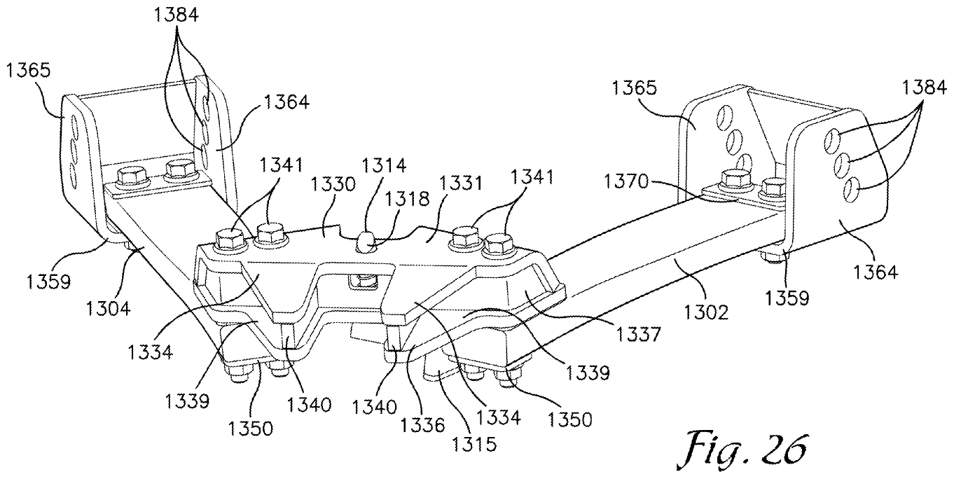

Referring now to FIGS. 25 and 26, the spring arm assembly 1300 includes at least one spring arm. Preferably, the spring arm assembly comprises a pair of spring arms 1302 and 1304, each spring arm 1302 and 1304 being connected to the hitch head engaging structure 1310 at a first end and connected to an actuator connecting structure 1320a and 1320b, respectively, at a second end. Similar to the engaging structure 310, the hitch head engaging structure 1310 is configured to be complementary to the spring arm mount 1112 of the hitch assembly 1100, whereby the spring arm assembly 1300 and the hitch assembly 1100 may be removably coupled together for use in towing a trailer 1200. The actuator connecting structures 1320a and 1320b of spring arm assembly 300 are each configured to be engaged by a first end 1420 of a linear actuator 1402a, 1402b.

Spring arms 1302 and 1304 may be rigidly attached to the hitch head engaging structure 1310. In the illustrated embodiment, the spring arms 1302 and 1304 are clamped to the hitch head engaging structure 1310 and secured thereto using simple mechanical fasteners such as bolts 1341 and corresponding nuts 1342. In other embodiments not shown, spring arms 1302 and 1304 may be welded to the hitch head engaging structure 1310, or rigidly attached via other methods known by those skilled in the art.

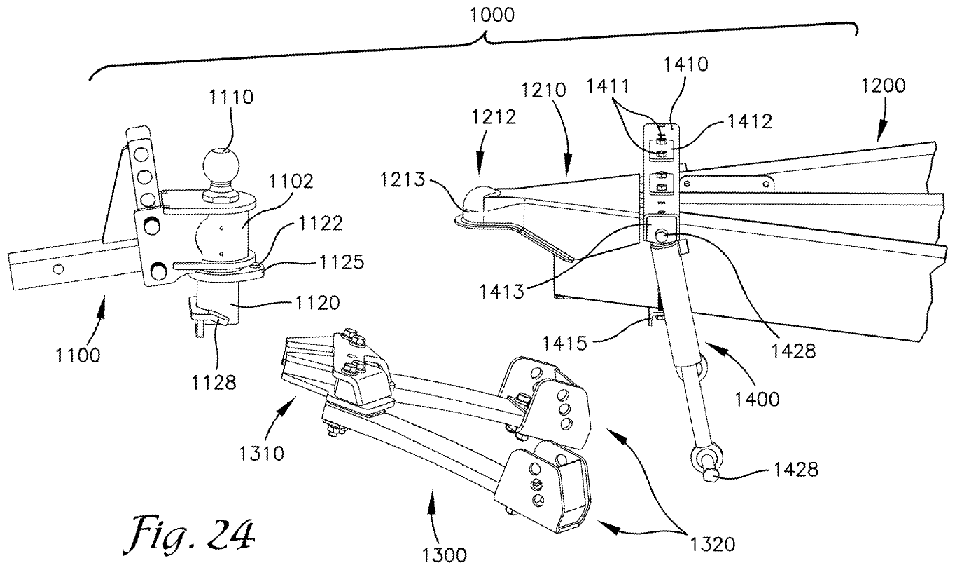

The spring arms 1302 and 1304 are connected together by the hitch head engaging structure 310 and extend rearward and angularly outward therefrom, unlike spring arms 302 and 304 which are substantially parallel to each other. Similar to spring arms 302 and 304, arms 1302 and 1304 have a generally rectangular cross section; however, it may be desirable in other embodiments for the spring arms 1302 and 1304 to have a variety of cross section shapes, such as square, circular, annular, et cetera. Likewise, in the embodiment shown the spring arms 1302 and 1304 have a cross section which varies in size along its length, while remaining a constant shape. For ease of manufacturing or cost, it may be desirable that the spring arms 1302 and 1304 maintain a constant cross section shape and size along their complete length. In the illustrated embodiment, the spring arms 1302 and 1304 have a curvature along their length, as is seen in FIGS. 24-26. In other embodiments, the spring arms may be substantially linear in shape, rather than curved as shown.

As with spring arms 302 and 304, spring arms 1302 and 1304 are preferably formed from a composite material such as a fiber reinforced polymeric material which, in some embodiments, may include thermoset resins. Generally, the composite material may be in the nature of fiberglass. Forming the spring arms 1302 and 1304 from these types of material may allow for a more complex geometry of arm, including curvature and taper as shown. The relatively lower material stiffness and high stress limit of the glass fiber-reinforced polymer (GFRP) material allows the spring arms to be shorter than typical steel spring arms. Additionally, GFRP reduces the weight of the design and may offer improved fatigue properties compared to steel. In other embodiments not seen, the spring arms 1302 and 1304 may be fashioned from metal, which may limit geometry but reduce the complexity and/or cost of the design.

The hitch head engaging structure 1310 of the spring arm assembly 1300 is similar to hitch head engaging structure 310, and generally comprises a fork secured to and projecting above and forward of the ends of the spring arms 1302 and 1304 and sized for securement around the central post 1120 of the spring arm mount 1112. In the embodiment shown, the hitch head engaging structure 1310 is bolted onto upper surfaces of the forward ends of the spring arms 1302 and 1304 and extends between and interconnects the forward ends of the spring arms 1302 and 1304. The hitch head engaging structure 1310 comprises an upper plate 1330, a lower plate 1336, and a spacer 1337 disposed between the upper plate 1330 and lower plate 1336. The hitch head engaging structure 1310 shown further comprises a pair of tines or prongs 1312a and 1312b separated by a gap 1311, a locking pin 1314, and a release mechanism 1315.

The upper plate 1330 includes a substantially planar top panel 1331, a rearwardly and downwardly angled face 1333, and projections 1334 projecting outward or forward from the top panel 1331. Projections 1334 form part of prongs 1312a and 1312b of the engaging structure 1310. The lower plate 1336 is generally planar with a base panel 1338 and projections 1339 projecting outward or forward therefrom. Spacer 1337 extends vertically between the upper and lower plates 1330 and 1336 to maintain an open space therebetween. Spacer 1337 includes projections 1340 extending between projections 1334 of the upper plate 1330 and projections 1339 of the lower plate 1336 to form the prongs 1312a and 1312b. Gap 1311 is formed between the projections 1334, 1339 and 1340 and is complimentary in shape to the central post 1120 of the hitch assembly 1100.

As, best seen in FIG. 26, mechanical fasteners or bolts 1340 inserted through aligned bolt holes in the upper plate 1330, lower plate 1336 and spring arms 1302 and 1304 are used with a rectangular bracket or washer 1350 and nuts 1351 to rigidly connect the engaging structure 1310 to the spring arms 1302 and 1304. The portions of the upper plate 1330, lower plate 1336 and spacer 1337 from which the respective projections 1334, 1339 and 1340 project and the washer 1350 may be referred to as the fork base 1355.

The locking pin 1314 substantially similar to locking pin 314 and is mounted on the hitch head engaging structure 1310 and may be biased upward by a spring or other biasing member 1313 through aligned pin receiving holes formed in the upper and lower plates 1330 and 1336. The spring 1313 is positioned around the locking pin 1314 with a lower end of the spring abutting an upper surface of the lower plate 1336 and an upper end of the spring abutting against a retaining ring or the like secured in a groove formed in the locking pin 1314. An upper surface 1318 of the locking pin 1314, extending above the upper plate 1330 when the pin 1314 is extended, slopes upward and rearward and generally forms a cam surface. As the prongs 1312a and 1312b of the hitch head engaging structure 1310 are advanced around the lower section 1122 of the central post 1120, the upper surface 1318 of the locking pin 314 engages a rear surface of the upper bearing plate 1125 and further forward advancement of the hitch head engaging structure 310 forces the locking pin 1314 downward against the biasing force of the spring 1313. When the hitch head engaging structure 1310 is advanced into engagement with the lower section 1122 of the central post 1120, the locking pin 1314 is aligned with and is biased upward into the pin receiving hole 134 in the upper bearing plate 1125 to prevent separation of the spring arm assembly 1300 from the hitch head 1102.

The plate 1330 may also include a notch spanning a central portion of the angled face 1333, such that a cavity 1316 is formed. The cavity 1316 is preferably adjacent to the locking pin 1314, in order to allow for access to the locking pin if needed during installation.

In other embodiments, the locking pin 1314 may be replaced by a small linear actuator, wherein the linear actuator may be raised or lowered in order to slidably engage with the hole 1134. In these embodiments, not shown, the linear actuator may be an electric motor, a hydraulic piston, a pneumatic piston, or any other linear actuation methods now known or future-developed. The use of a linear actuator may remove the need for a biasing member completely, as the length of the pin can be controlled actively, rather than through passive means such as a mechanical spring.

To facilitate uncoupling of the spring arm assembly 1300 from the hitch assembly 1100, the hitch head engaging structure 1310 may further include a release mechanism 1315. The release mechanism 1315 may serve to lower the locking pin 1314. Preferably, the locking pin 1314 may be lowered below the lowermost surface of the upper bearing plate 1125. In this configuration, the spring arm assembly 1300 may be slidably decoupled from the hitch assembly 1100. In the illustrated embodiment, the release mechanism 1315 is a lever, wherein an end of the lever is connected to the bottom of the locking pin, the second end is free, and the pivot point 1316 falls in between the first and the second end. To improve ergonomics, the lever 1315 may have a connecting portion 1315a and a tab 1315b, wherein the tab 1315b is located at the free end of the lever. In the illustrated embodiment, the tab 1315 extends horizontally from the lever. To lower the locking pin 1314 and therefore decouple the spring arm assembly 1300 from the hitch assembly 1100, the user lifts or pivots the free end of the lever upwards (i.e., towards the hitch ball 1110) on the tab 1315 which pivots the opposite end and the locking pin 1314 connected thereto downward against the biasing force of the spring 1313.

At the rear ends of each of the spring arms 1302 and 1304 is an actuator connecting structure 1320a (connected to spring arm 1302) and 1320b (connected to spring arm 1304), respectively. Each of the actuator connecting structures 1320, also referred to as a rear bracket, is clamped to its respective spring arm by mechanical fasteners, such as bolts 1371. In some embodiments, the mechanical fasteners 1371 may clamp directly to the spring arms 1302, 1304, while in other embodiments the fasteners and spring arms may be separated by a washer 1370.

Each of the actuator connecting structures 1320a and 1320b generally comprises a clevis or substantially U-shaped bracket 1359, the clevis 1359 having vertical plates 1364 and 1365 which extend substantially upwards. The vertical plates 1364 and 1365 each include at least one through hole 1384 which are substantially horizontally and axially aligned along a substantially horizontal axis. An eyelet 1418 on an end of a piston 1420 of a respective linear actuator 1402a, 1402b is securable to the clevis pin 1382 through the holes 1384 for connecting a lower end of the linear actuator 1402a, 1402b to the rear end of the spring arm assembly 1300. Preferably, the clevis plates 1364 and 1365 each include a plurality of corresponding holes 1384 which allow the linear actuator 1402a or 1402b to be mounted at a plurality of heights, depending on the application.

In the preferred embodiment, the eyelet 1418 of each linear actuator 1402a, 1402b includes a spherical rod end bearing 1422. It is foreseen that the rod end bearing 1422 may also be referred to as a heim joint or rose joint, or that the rod end bearing may instead be a classical spherical joint or ball joint. Similar to linear actuator assembly 400 in FIG. 14, the rod end bearing 1422 is mounted within the eyelet 1418 and is formed as a truncated sphere with a bore 1424 extending therethrough which is sized to receive the clevis pin 1382 which connects the linear actuator 1402a, 1402b to the spring arm assembly 1300 at the actuator connecting structure 1320a, 1320b. The heim joint allows the spring arm assembly to rotate about two axes; a substantially horizontal axis as the linear actuator applies the load to the spring arm assembly, and a longitudinal axis which extends generally through the center of the hitch ball 1110 in the direction of the trailer frame center support 1206. The ability to rotate about the longitudinal axis allows for the trailer to rotate independently from the towing vehicle, which may be beneficial when towing on uneven terrain.

The linear actuator assembly 1400 comprises a pair of linear actuators 1402a and 1402b and upper and lower trailer frame mount brackets 1410 and 1415. A first end of the first linear actuator 1402a is pivotally connected to the upper trailer frame mount bracket 410 proximate a first end. In the embodiment shown, an eyelet 1425 on the base 1426 of the actuator barrel 1406 is pivotally connected to a pin 1428 mounted on upper trailer frame mount bracket 1410. As discussed previously, the eyelet 1418 on the distal end of the piston 1420 is pivotally connected to pin 1382 on the actuator connecting structure 1320 or 1320b, respectively. The upper trailer frame mount bracket 1410 may be substantially U-shaped, and may extend generally between the trailer arms 1202 and 1204. The upper bracket 1410 may include a plurality of through holes, allowing for the use of mechanical fasteners such as bolts 1411, washers 1412, and nuts 1414 to engage with the lower trailer mount bracket 1415. In some embodiments, and similar the actuator assembly 400 shown in FIG. 11, the upper bracket 1410 includes one or more slots extending longitudinally, rather than a plurality of through holes. The brackets 1410 and 1415 form a clamping mechanism, wherein tightening the bolts 1411 and nuts 1414 forms a rigid connection between the brackets 1410 and 1415 and the trailer frame 1200. Unlike the actuator assembly 400, wherein the linear actuator is mounted substantially along the centerline of the upper bracket 410, the actuators 1402a and 1402b are mounted on opposing ends of the bracket 1410, generally above the respective spring arms 1302 and 1304, and outside the perimeter of the trailer frame 201.

The upper trailer frame mount bracket 1410 includes a pair of projections 1413 extending generally downward from a lower surface of the bracket. The projections 1413 each contain a through hole positioned to align coaxially with the eyelet 1425 on the base 1426 of the linear actuator 1402a, and is sized to engage with the pin 1428. Linear actuator 1402b is mounted in an identical fashion using identical downward projections 1413 positioned proximate an opposite side of the upper bracket 1410.

The linear actuators 1402a and 1402b may be substantially vertical, or, as in the illustrated embodiment, angularly offset from vertical by a desired amount. With the spring arm assembly 1300 connected to the hitch head 1102 and the linear actuators 1402a and 1402b, retraction of the pistons 420 of the linear actuators 1402a, 1402b applies an upwardly directed load on the rear ends of the spring arms 1302 and 1304 which creates a reaction moment at the opposite ends of the spring arm assembly 1300. This tension and reactionary moment shift the effective towing load forwards within the towing vehicle, thereby returning the load on the front axle of the towing vehicle to its desired level, and significantly reducing the potential for reduced steering control, similar to the hitch system 10.

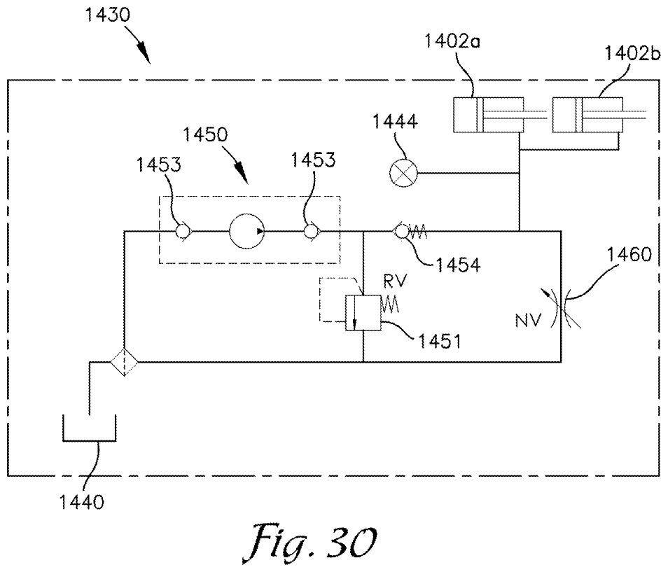

As shown in FIG. 30, the linear actuator assembly 1400 may include a hydraulic control assembly 1430 that is substantially similar to the hydraulic control assembly 430 shown in FIGS. 13 and 15A-C, except that the hydraulic actuators 1402a and 1402 may be connected in parallel, such that they receive substantially equal hydraulic pressure from the pump 1450 during operation. The hydraulic control assembly 1430 may be mounted directly to the trailer frame 1200. This may be done using a clamping bracket 1432 which may include a baseplate 1431 on which the hydraulic control assembly 1430 is mounted and connected to the trailer frame 1200. The hydraulic control assembly 1430 comprises a hydraulic fluid reservoir 1440, a pump 1450, a control valve or needle valve 1460 having handle 1462, and a pressure indicator 1444. The hydraulic control assembly 1430 is connected to the linear actuators 1402a and 1402b via at least one hydraulic line 1442. In some embodiments, it may be desirable for the hydraulic control assembly to also include a pressure relief valve 1451 (not shown), which may improve safety and reduce the risk of damaging the assembly during operation. This relief valve 1451 may be used for both actuators 1402a and 1402b, or there may be a plurality of relief valves 1451 such that there is a dedicated relief valve 1451 for each actuator 1402a and 1402b.

The hydraulic pump 1450 may be manually operated using pump handle 1452 as shown in FIG. 22 or may be electronically controlled. Pump handle 1452 may be of a type adapted to receive a tire iron or an elongated bar to serve as a lever arm to facilitate operation of the pump 1450. In some embodiments, the pump handle may be collapsible and/or rotatable into a storage configuration during transportation. The pump 1450 may contain one or more internal check valves 1453, similar to the hydraulic control assembly 430 shown in FIGS. 15A-C. Additionally, the hydraulic assembly 1430 in the illustrated embodiment includes an additional check valve 1454, which may help reduce leakage through the pump assembly. The pressure indicator 1444 may be an analog pressure gauge as shown in the illustrated embodiment or may alternatively be a pressure sensor connected to a digital readout display.

The needle valve 1460 is moveable using the valve dial 1462 between an open position in which hydraulic fluid can flow under pressure from the barrel 1406 of the linear actuator 1402 to the hydraulic fluid reservoir 1440 and a closed position in which hydraulic fluid is held in the barrel 1406 of the actuator to maintain the piston 1420 at a selected extension relative to the barrel 1406 and maintain the spring arm assembly 1300 under a desired load or in which additional fluid may be added to the barrel 1406 through the pump 1450 in order to move the pistons 1420 towards the desired extension relative to the barrel.

A user may determine the appropriate hydraulic pressure, or other appropriate parameters (e.g., when the actuators 1402a and 1402b are electrically-operated rather than hydraulic) using methods described above in relation to the operation of the weight distributing hitch system 10 for operation of the weight distributing hitch system 1000. This includes, but is not limited to, using existing data (e.g., from a database or mobile phone application) to determine an appropriate hydraulic pressure (or similar parameter) for a given tongue weight and desired FALR.

In some embodiments, the weight distributing hitch assembly 1000 may include a jack cradle which is substantially similar in design and function to the cradle 540 shown in FIGS. 16-21. Like cradle 540, the cradle is may be releasable securable to a portion (preferable a lower portion) of a trailer jack 1500 at a first end, and is configured to hold the hitch head engaging structure 1310 when the trailer is stationary and/or the trailer is not coupled to a towing vehicle.

It is to be understood that while certain forms of the present invention have been illustrated and described herein, it is not to be limited to the specific forms or arrangement of parts described and shown. As used in the claims, identification of an element with an indefinite article “a” or “an” or the phrase “at least one” is intended to cover any device assembly including one or more of the elements at issue. Similarly, references to first and second elements is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

What is claimed is:

1. A weight distributing hitch system for towing a trailer behind a vehicle, the trailer having a trailer frame and a coupler mounted on a front end of the trailer frame, the weight distributing hitch system comprising:
a hitch ball mount and a hitch ball connected to the hitch ball mount;
a spring arm assembly comprising:
first and second spring arms, each having a first end and a second end;
a hitch ball mount engaging structure mounted on a front bracket, the front bracket extending over the first ends of the first and second spring arms, the hitch ball mount engaging structure configured to removably and pivotally engage with the hitch ball mount such that the weight distributing hitch pivots about an axis extending through the hitch ball; and
an actuator mount connected to a rear bracket, the actuator mount having a portion extending under the second end of at least one of the first and second spring arms; and
a linear actuator assembly comprising:
an actuator mounting bracket securable to the trailer frame behind trailer coupler; and
a linear actuator having a first end and a second end, wherein the first end is connected to the actuator mount of the spring arm assembly, and the second end is connected to the actuator mounting bracket.

2. The weight distributing hitch system as in claim 1 wherein said actuator mount comprises a clevis with at least one pair of aligned openings in which an actuator mounting pin is received.

3. The weight distributing hitch system as in claim 1 wherein said actuator mount comprises first and second clevis plates, each of the first and second clevis plates having a pin receiving slot extending therethrough in which an actuator mounting pin is received, the first and second clevis plates connected to the rear bracket by means for adjusting a vertical position of the pin receiving slots of the first and second clevis plates relative to the rear bracket.

4. The weight distributing hitch system as in claim 1 wherein the hitch ball mount engaging structure comprises a fork.

5. The weight distributing hitch system as in claim 4 wherein hitch ball mount includes a flange having a pin receiving hole formed in a portion of the flange extending rearward and a locking pin is mounted on the fork and biased to engage the pin receiving hole when the fork engaging engages the hitch ball mount.

6. The weight distributing hitch as in claim 1 wherein the first and second spring arms are formed from a fiber reinforced composite material.

7. The weight distributing hitch system as in claim 1 wherein the linear actuator is a hydraulic actuator and the weight distributing hitch system further comprises a hydraulic assembly comprising a hydraulic fluid reservoir, a pump for pumping hydraulic fluid from the hydraulic fluid reservoir to the pump through a hydraulic fluid supply line and a check valve is positioned on the hydraulic fluid supply line between the pump and the hydraulic actuator to limit draining of hydraulic fluid from the actuator past the check valve and through the pump.

8. The weight distributing hitch system as in claim 7 further including a pressure relief valve connected to hydraulic fluid reservoir at one end and connected to the hydraulic fluid supply line between the pump and the check valve at a second end; the relief valve being configured to return hydraulic fluid to the hydraulic fluid reservoir upon a pressure of the hydraulic assembly reaching a first predetermined threshold value.

9. The weight distributing hitch system as in claim 8 further comprising a second pressure relief valve connected to the hydraulic fluid reservoir at one end and connected to the hydraulic fluid supply line between the check valve and the actuator at a second end; the second pressure relief valve being configured to return hydraulic fluid to the hydraulic fluid reservoir upon a second pressure of the hydraulic assembly reaching a predetermined threshold value, the second threshold pressure being higher than the first threshold pressure.

10. The weight distributing hitch system as in claim 8 further comprising:
a hydraulic fluid return line connecting the hydraulic actuator to the reservoir and a needle valve on the hydraulic fluid return line operable to control a rate of flow of hydraulic fluid from the hydraulic actuator to the reservoir; and
a hydraulic accumulator located between the actuator and the needle valve on the hydraulic return line; the hydraulic accumulator being configured to receive hydraulic fluid from the actuator upon a second pressure of the hydraulic assembly reaching a predetermined threshold value, the second threshold pressure being higher than the first threshold pressure.

11. The weight distributing hitch system as in claim 7 wherein the hydraulic assembly further comprises a hydraulic fluid return line connecting the hydraulic actuator to the reservoir and a needle valve on the hydraulic fluid return line operable to control a rate of flow of hydraulic fluid from the hydraulic actuator to the reservoir.

12. The weight distributing hitch system as in claim 7 wherein the hydraulic assembly further comprises a pressure indicator between the check valve and the hydraulic actuator.

13. The weight distributing hitch as in claim 1 wherein the at least one actuator mount includes a portion extending under the second end of at least one of the first and second spring arms.

14. A weight distributing hitch system for towing a trailer behind a vehicle, the trailer having a trailer frame and a coupler mounted on a front end of the trailer frame, the weight distributing hitch system comprising:
a hitch ball mount and a hitch ball connected to the hitch ball mount;
a spring arm assembly comprising:
first and second spring arms, each having a first end and a second end;
a hitch ball mount engaging structure mounted on and interconnecting the first ends of the first and second spring arms, the hitch ball mount engaging structure configured to removably and pivotally engage with the hitch ball mount; and
an actuator mount connected to a rear bracket, the actuator mount extending between and rearwardly from the second ends of the first and second spring arms and comprising first and second clevis plates, each plate having a slot configured to receive an actuator mounting pin and connected to the rear bracket by means for adjusting a vertical position of the pin receiving slots of the first and second clevis plates relative to the rear bracket; and
a linear actuator assembly comprising:
an actuator mounting bracket securable to the trailer frame behind trailer coupler;
a linear actuator having a first end and a second end, wherein the first end connects to the actuator mount of the spring arm assembly, and the second end connects to the actuator mounting bracket.

15. The weight distributing hitch system as in claim 14, wherein the first end of the linear actuator includes a spherical rod end bearing.

16. The weight distributing hitch system as in claim 14, further comprising:
a trailer jack coupled to the front end of the trailer frame;
a bracket having a first end and a second end vertically offset from the first end, wherein the first end is releasably securable to a lower portion of the trailer jack and the second end is configured to support the hitch ball mount engaging structure.

17. A weight distributing hitch system for towing a trailer behind a vehicle, the trailer having a trailer frame and a coupler mounted on a front end of the trailer frame, the weight distributing hitch system comprising:
a hitch ball mount and a hitch ball connected to the hitch ball mount;
a spring arm assembly comprising:
first and second spring arms, each having a first end and a second end;
a hitch ball mount engaging structure mounted on and interconnecting the first ends of the first and second spring arms, the hitch ball mount engaging structure configured to removably and pivotally engage with the hitch ball mount;
a first actuator mount connected to and extending rearwardly from the second end of the first spring arm, the first actuator mount comprising first and second clevis plates having a plurality of holes, each hole configured to receive an actuator mounting pin at a plurality of vertical positions; and
a second actuator mount connected to and extending rearwardly from the second end of the second spring arm, the second actuator mount comprising first and second clevis plates having a plurality of holes, each hole configured to receive an actuator mounting pin at a plurality of vertical positions; and
a linear actuator assembly comprising:
an actuator mounting bracket securable to the trailer frame behind trailer coupler;
a first linear actuator having a first end and a second end, wherein the first end connects to the first actuator mount, and the second end connects to the actuator mounting bracket; and
a second linear actuator having a first end and a second end, wherein the first end connects to the second actuator mount, and the second end connects to the actuator mounting bracket.

18. The weight distributing hitch system as in claim 17, wherein the first and second linear actuators are hydraulic actuators and the weight distributing hitch system further comprises:
a hydraulic fluid reservoir;
a pump for pumping hydraulic fluid from the hydraulic fluid reservoir to the pump through a hydraulic fluid supply line; and
a check valve is positioned on the supply line between the pump and the first and second hydraulic actuators to limit draining of hydraulic fluid from the actuator past the check valve and through the pump.

19. A method of connecting a trailer to a towing vehicle wherein the trailer includes a coupler mounted on a front end of a trailer frame of the trailer, the method comprising:
providing a weight distributing hitch system comprising:
a hitch ball mount having a hitch ball;
a spring arm assembly having first and second spring arms, each having a first end and second end, and an actuator engaging structure connected to at least one of the first and second spring arms; and
a linear actuator assembly having a linear actuator mounting bracket and a linear actuator having a first and second end;
attaching the first ends of the first and second spring arms to the hitch ball mount;
attaching the first end of the linear actuator to the linear actuator mounting bracket;
pivotally attaching the second end of the linear actuator to the actuator engaging structure such that the first end of the linear actuator extends rearward of the second end of the spring arms; and
securing the linear actuator bracket to the trailer frame rearward of the trailer coupler.

20. The method as in claim 19, wherein a propane tank mounting assembly is mounted to a top surface of the trailer frame in spaced relation rearward of the trailer coupler, the method further comprising:
attaching the linear actuator mounting bracket to the trailer frame between the trailer coupler and the propane tank mounting assembly.

21. The method as in claim 19, wherein the first ends of the first and second spring arms are connected to a hitch ball mount engaging structure and the method further comprises slidably engaging the hitch ball mount engaging structure with the hitch ball mount which causes a locking pin disposed on the hitch ball mount engaging structure to engage with a slot disposed on the hitch ball mount.

22. A method of restoring load to a front axle of a towing vehicle having a trailer connected to the towing vehicle, the method comprising:
providing a user with a hitch assembly including a hitch head including a hitch ball and a hitch ball mount, a spring arm assembly connectable to the hitch ball mount, a hydraulic actuator connectable between the spring arm assembly and a trailer frame of the trailer; a pump connected between the hydraulic actuator and a hydraulic fluid reservoir by a hydraulic fluid supply line and a pressure gauge connected to the hydraulic fluid supply line between the pump and the hydraulic actuator providing pressure readings indicative of the pressure of the hydraulic fluid in the hydraulic fluid supply line;
providing the user with access to tabulated data indicating target pressures of hydraulic fluid in the hydraulic fluid supply line corresponding to front axle load restoration percentages between 50% and 100% for selected tongue weights based upon a load imparted on the spring arm assembly by retraction of the actuator in response to pressure exerted thereon by the hydraulic fluid in the hydraulic supply line;
instructing the user to connect the hitch assembly to the towing vehicle, to connect the spring arm assembly to the hitch ball mount, and to connect the actuator between the spring arm assembly and the trailer frame;
instructing the user to determine a tongue weight of the trailer connected to the towing vehicle;
instructing the user to access the tabulated data and determine a target pressure of the hydraulic fluid in the hydraulic fluid supply line based upon the tongue weight determined by the user and the front axle load restoration percentage selected by the user; and
instructing the user to operate the pump until a pressure reading from the pressure gauge corresponds to the target pressure.

23. A method of restoring load to a front axle of a towing vehicle having a trailer connected to the towing vehicle by a hitch assembly having a hitch head, a spring arm assembly connected to the hitch head, a linear actuator connected between the spring arm assembly and a trailer frame of the trailer, and a gauge providing readings of a numerical value of a parameter correlated to a force exerted by the linear actuator on the spring arm assembly, the method comprising:
determining a tongue weight of the trailer connected to the towing vehicle;
selecting a front axle load restoration percentage;
accessing tabulated data providing target parameters corresponding to front axle load restoration percentages between 50% and 100% for selected tongue weights based upon a load imparted on the spring arm assembly by the actuator;
determining the target parameter based upon the determined tongue weight and the selected front axle load restoration percentage; and
operating the actuator until a numerical reading from the gauge corresponds to the target parameter.
